(19) United States
(12) Patent Application Publication
(10) Pub. No.: US 2023/0072082 A1
(43) Pub. Date: Mar. 9, 2023

(54) DEEP NEURAL NETWORK (DNN) ACCELERATOR FACILITATING ACTIVATION COMPRESSION

(71) Applicants: Sudheendra Kadri, Folsom, CA (US); Andrea Deidda, Celbridge (IE); Hassan Kamal, Clonee (IE); Martin-Thomas Grymel, Leixlip (IE); Alfonso Tarazona Martinez, Celbridg. (IE); David Thomas Bernard, Kilcullen (IE)

(72) Inventors: Sudheendra Kadri, Folsom, CA (US); Andrea Deidda, Celbridge (IE); Hassan Kamal, Clonee (IE); Martin-Thomas Grymel, Leixlip (IE); Alfonso Tarazona Martinez, Celbridg. (IE); David Thomas Bernard, Kilcullen (IE)

(21) Appl. No.: 18/050,944

(22) Filed: Oct. 28, 2022

(51) Int. Cl. G06N 3/08

(52) U.S. Cl. CPC G06N 3/082

(57) ABSTRACT

A system includes a first memory, a compiler, and a DNN accelerator. The DNN accelerator includes a DMA engine, an acceleration module, and a compute block. The compute block includes a second memory. The compiler may generate a task for transferring activations from the second memory to the first memory. The DMA engine may receive the task and read the activations from the second memory. The acceleration module may compress the activations to generate compressed activation data and write the compressed activation data into the external memory. The acceleration module may also store a size of the compressed activation data in the local memory, which may be used by the DMA engine to read the activation from the first memory to the second memory later. The compressed activation data may include non-zero activations and sparsity bitmaps. The compressed activation data may also include a header or zeropoint marker.

### TECHNICAL FIELD

This disclosure relates generally to neural networks, and more specifically, DNN accelerator facilitating activation compression.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 illustrates an example convolution, in accordance with various embodiments.

FIG. 3 is a block diagram of a DNN system, in accordance with various embodiments.

FIG. 4 illustrates an activation spill process in a DNN system, in accordance with various embodiments.

FIG. 5 is a block diagram of a direct memory access (DMA) engine, in accordance with various embodiments.

FIG. 6 illustrates data transfer with Remote Width Fetch, in accordance with various embodiments.

FIG. 7 illustrates data transfer with Remote Width Store, in accordance with various embodiments.

FIG. 8 is a block diagram of an acceleration module, in accordance with various embodiments.

FIG. 9 illustrates a memory layout where activation vectors and sparsity bitmaps are stored separately, in accordance with various embodiments.

FIG. 10 illustrates another memory layout where activation vectors and sparsity bitmaps are stored separately, in accordance with various embodiments.

FIG. 11 illustrates a memory layout including consecutive data packages, each of which includes a sparsity bitmap and an activation vector, in accordance with various embodiments.

FIG. 12 illustrates a memory layout including consecutive data packages, each of which includes a sparsity bitmap, a header, and a sequence of activations, in accordance with various embodiments.

FIG. 13 illustrates a memory layout including sequential data packages, each of which includes a sequence of activations and a zeropoint marker, in accordance with various embodiments.

FIG. 14 illustrates a memory layout including sequential, consecutive data packages, each of which includes a sequence of activations and a zeropoint, in accordance with various embodiments.

FIG. 15 is a flowchart showing a method of deep learning, in accordance with various embodiments.

FIG. 16 illustrates an MAC array, in accordance with various embodiments.

FIG. 17 illustrates a deep learning environment, in accordance with various embodiments.

FIG. 18 is a block diagram of an example DNN system, in accordance with various embodiments.

FIG. 19 is a block diagram of an example computing device, in accordance with various embodiments.

### DETAILED DESCRIPTION

Overview

The last decade has witnessed a rapid rise in AI (artificial intelligence) based data processing, particularly based on DNN. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

DNN applications are usually run on DNN accelerators. DNN accelerators process a large capacity of data for inference tasks, which have been a bottleneck for energy efficiency. Reducing data transfer (memory access), maximizing data reuse and resource utilization, and reducing the total number of computations for the same amount of work done can be essential to improve energy efficiency. Peak TOPS (Tera Operations Per Second) has been a metric to measure performance of DNN accelerators. For energy-constrained edge devices, two other metrics, TOPS/mm² (which indicates performance per area) and TOPS/W (which indicates performance per power) are also used.

Data movement is a key driver of power consumption and performance in DNN accelerators performing edge inference. Some DNNs include hidden layers that produce data having a size that exceeds the internal cache of the DNN accelerator. In such cases, activations of such hidden layers are spilled to an external memory associated with the DNN accelerator. Such spilled activations can be compressed to reduce the size of the data spilled and then retrieved back from the external memory.

Compilation of DNN models for execution on edge DNN accelerators involves producing an optimal graph of data movement and DNN compute tasks. An offline schedule of such tasks is possible for cases where all data movement sizes are known at compile time. Compressed activations spilled to the external memory do not fall under this bucket, since hidden layer data are not known at compile time but change from inference to inference. Hence the compressed size of a layer cannot be embedded in the compiled task graph.

A current solution to this problem uses discrete levels of compression, while storing the start of a “Compression Tile” at a dense address offset to circumvent the problem of not knowing the compressed size. A separate set of “Tile Status” bits is used by the decompressor to correctly read just the valid chunks within the Compression Tile to achieve memory bandwidth savings. However, this solution has drawbacks. The primary disadvantage of this solution is the silicon area needed to cache the Tile Status bits to get continuous high throughput on the reads. Secondly, the achievable compression is reduced due to the discrete compressed storage format and the additional overhead of the Tile Status bits. Also, there are no performance (latency) benefits since the DMA (client) is always reading uncompressed size and hence no acceleration due to compression. Therefore, improved technology for compressing activations of hidden layers in DNNs is needed.

Embodiments of the present disclosure may improve on at least some of the challenges and issues described above by providing a DNN accelerator that can facilitate compression and decompression of activation data transferred between a local memory of a compute block and an external memory. The local memory may be implemented on a same chip as an MAC array that performs MAC operations. The external memory may be arranged outside the compute block or even the DNN accelerator.

In addition to the compute block, the DNN accelerator also includes a DMA engine and an acceleration module. The DMA engine may execute data transfer tasks to transfer data between the external memory and the local memory. The data may be activations of a DNN, e.g., activations of a convolution, activation function, or other types of deep learning operations. The activations may be a result of a deep learning operation, an input of a deep learning operation, or both. Activations may be spill in and out from the local memory as the storage capacity of the local memory may be insufficient to store all activations for a layer. In an example, activations generated by a hidden layer in the DNN may be transferred from the local memory to the external memory. Later, the activations may be transferred back to the local memory for the execution of the next layer of the DNN.

The acceleration module may include a compressor that may compress activation data read by the DMA engine from the local memory. The compressor may include a sparsity packer than can pack activations with other data to facilitate identification of the start of each activation vector in the activation data to accelerate deep learning operations. The other data may include sparsity bitmap, header indicating the number of stored activations (e.g., non-zero valued activations) in an activation vector, zeropoint marker (i.e., a zero data point). The compressor may compress the data packages by using various compression methods, e.g., entropy coding. The compressor may write the compressed activation data into the external memory. The compressor may also determine a size of the compressed activation data and store the size in the local memory. The size of the compressed activation data may be referred to as a compressed size, data width, or remote width.

At a later time when the activations are needed for executing the next layer, the DMA engine may read the compressed size from the local memory and use the compressed size to read the compressed activation data from the external memory. The DMA engine may transmit the compressed activation data to the decompressor in the acceleration module to decompress the compressed activation data and restore the activation data. The decompressor may include a sparsity unpacker that can unpack the data packages and form sparse tensors. The decompressor may store the activation data into the local memory after the decompression and unpacking.

The present disclosure provides a method to determine compressed size and therefore provide a more advantageous method of data transfer. The hardware implementation is relatively simple and the cost to implement the support for the storing and fetching of compressed size is relatively low in terms of area and power. But the data transfer method in this present disclosure can have high throughput and frequency with lower latency, which can provide better TOPs/mm2 and TOPs/W. The present disclosure may be applied even in area sensitive system-on-chip designs. Moreover, with the formation of data packages that include activations and other data indicating the start or end of every activation vector, the logic required to identify the start of an activation vector may be minimized. Also, the memory footprint, bandwidth and energy cost can be reduced. This can further improve the performance of the DNN accelerator.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The DNN systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Example DNN

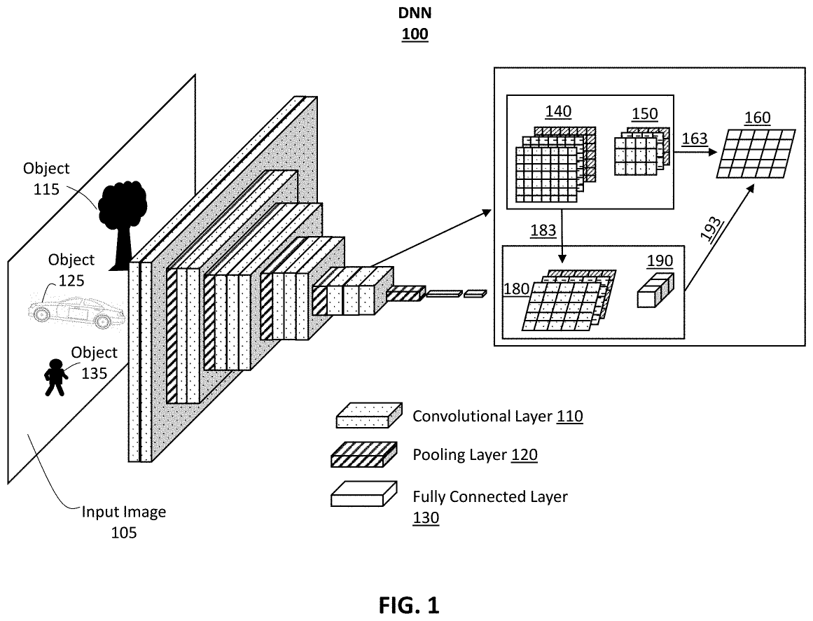

FIG. 1 illustrates an example DNN 100, in accordance with various embodiments. For purpose of illustration, the DNN 100 in FIG. 1 is a convolutional neural network (CNN). In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as input feature map (IFM) 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

Example Convolution

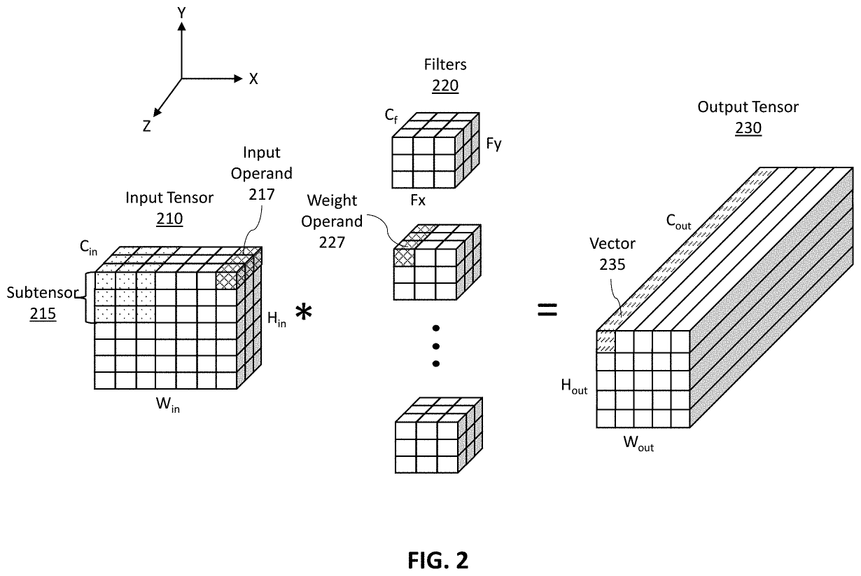

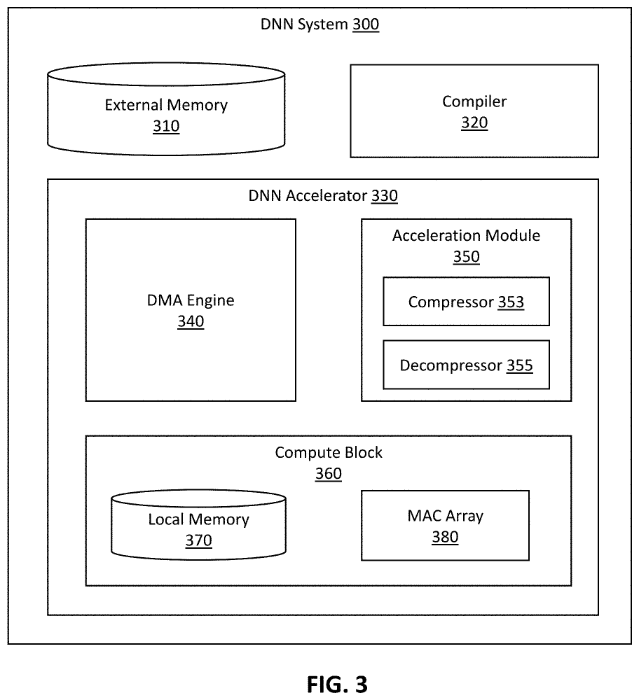

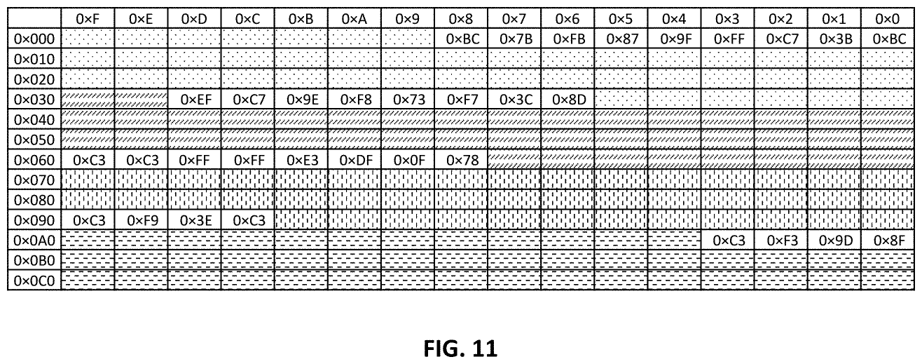

FIG. 2 illustrates an example convolution, in accordance with various embodiments. The convolution may be a convolution in a convolutional layer of a DNN, e.g., a convolutional layer 110 in FIG. 1. The convolution can be executed on an input tensor 210 and filters 220 (individually referred to as “filter 220”). A result of the convolution is an output tensor 230. In some embodiments, the convolution is performed by a DNN accelerator including one or more compute tiles. An example of the DNN accelerator may be the DNN accelerator 1100 in FIG. 11. Examples of the compute tiles may be the compute tiles 1130 in FIG. 11. A compute tile may be a compute block, such as the compute block 360 in FIG. 3.

In the embodiments of FIG. 2, the input tensor 210 includes activations (also referred to as “input activations,” “elements,” or “input elements”) arranged in a 3D matrix. An input element is a data point in the input tensor 210. The input tensor 210 has a spatial size Hᵢₙ×Wᵢₙ×Cᵢₙ, where Hᵢₙ is the height of the 3D matrix (i.e., the length along the Y axis, which indicates the number of activations in a column in the 2D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For purpose of simplicity and illustration, the input tensor 210 has a spatial size of 7×7×3, i.e., the input tensor 210 includes three input channels and each input channel has a 7×7 2D matrix. Each input element in the input tensor 210 may be represented by a (X, Y, Z) coordinate. In other embodiments, the height, width, or depth of the input tensor 210 may be different.

Each filter 220 includes weights arranged in a 3D matrix. The values of the weights may be determined through training the DNN. A filter 220 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 220 in FIG. 2 has a spatial size of 3×3×3, i.e., the filter 220 includes 3 convolutional kernels with a spatial size of 3×3. In other embodiments, the height, width, or depth of the filter 220 may be different. The spatial size of the convolutional kernels is smaller than the spatial size of the 2D matrix of each input channel in the input tensor 210.

An activation or weight may take one or more bytes in a memory. The number of bytes for an activation or weight may depend on the data format. For example, when the activation or weight has a INT8 format, the activation takes one byte. When the activation or weight has a FP16 format, the activation or weight takes two bytes. Other data formats may be used for activations or weights.

In the convolution, each filter 220 slides across the input tensor 210 and generates a 2D matrix for an output channel in the output tensor 230. In the embodiments of FIG. 2, the 2D matrix has a spatial size of 5×5. The output tensor 230 includes activations (also referred to as “output activations,” “elements,” or “output element”) arranged in a 3D matrix. An output activation is a data point in the output tensor 230. The output tensor 230 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Cₒᵤₜ may equal the number of filters 220 in the convolution. Hₒᵤₜ and Wₒᵤₜ may depend on the heights and weights of the input tensor 210 and each filter 220.

As a part of the convolution, MAC operations can be performed on a 3×3×3 subtensor 215 (which is highlighted with a dotted pattern in FIG. 2) in the input tensor 210 and each filter 220. The result of the MAC operations on the subtensor 215 and one filter 220 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 215 and all the filters 220 are finished, a vector 235 is produced. The vector 235 is highlighted with slashes in FIG. 2. The vector 235 includes a sequence of output activations, which are arranged along the Z axis. The output activations in the vector 235 have the same (x, y) coordinate, but the output activations correspond to different output channels and have different Z coordinates. The dimension of the vector 235 along the Z axis may equal the total number of output channels in the output tensor 230. After the vector 235 is produced, further MAC operations are performed to produce additional vectors till the output tensor 230 is produced.

In some embodiments, the MAC operations on a 3×3×3 subtensor (e.g., the subtensor 215) and a filter 220 may be performed by a plurality of MAC units. One or more MAC units may receive an input operand (e.g., an input operand 217 shown in FIG. 2) and a weight operand (e.g., the weight operand 227 shown in FIG. 2). The input operand may be also referred to as an input vector or activation vector. The weight operand may be also referred to as a weight vector. The input operand 217 includes a sequence of activations having the same (x, y) coordinate but different z coordinates. The input operand 217 includes an activation from each of the input channels in the input tensor 210. The weight operand 227 includes a sequence of weights having the same (x, y) coordinate but different z coordinates. The weight operand 227 includes a weight from each of the channels in the filter 220. Activations in the input operand 217 and weights in the weight operand 227 may be sequentially fed into a MAC unit. The MAC unit may receive a pair of an activation and a weight at a time and multiple the activation and the weight. The position of the activation in the input operand 217 may match the position of the weight in the weight operand 227. The activation and weight may correspond to the same channel.

Example DNN System

FIG. 3 is a block diagram of a DNN system 300, in accordance with various embodiments. The DNN system may run DNN models, e.g., the DNN 100 in FIG. 1. As shown in FIG. 3, the DNN system 300 includes an external memory 310, a compiler 320, and a DNN accelerator 330. In other embodiments, alternative configurations, different or additional components may be included in the DNN system 300. For instance, the DNN system 300 may include more than one DNN accelerator 330, more than one external memory 310, or more than one compiler 320. Further, functionality attributed to a component of the DNN system 300 may be accomplished by a different component included in the DNN system 300 or by a different system.

The external memory 310 stores data generated or to be used by the DNN accelerator 330 to execute DNN models. The external memory 310 may be outside the DNN accelerator. In some embodiments, the external memory 310 includes one or more DRAMs (dynamic random-access memory). In embodiments where the external memory 310 stores data for a convolution, the external memory 310 may store activations of the convolution. The activations may be input activations or output activations of the convolution. Output activations may be written into the external memory 310 by the DMA engine 340 from the local memory 370. Input activations may be read from the external memory 310 by the DMA engine 340 into the local memory 370. The same activations may be written into the external memory 310 from the local memory 370, and later be read from the external memory 310 by the DMA engine 340 into the local memory 370. The reason for the data movement may be because the local memory 370 lacks sufficient storage capacity to store the activations. In some embodiments, the external memory 310 has a larger storage capacity than the local memory 370. The external memory 310 may be a main memory of the DNN system 300.

Activations of a convolution may be stored in the external memory 310 in accordance with a memory layout that can facilitate efficient computation of the activations by the MAC array 380. In the memory layout, activations from the same activation action may be stored at consecutive addresses. An activation vector includes a sequence of activations crossing some or all the channels. Each activation may correspond to a different channel. An example memory layout is an NHWC memory layout, where N is the batch number, H is the height of the tensor, W is the width of the tensor, and C is the number of channels. In an NHWC memory layout, a plurality of activation vectors are stored one after another in an order determined based on their (x,y) coordinates. For instance, the activations in the (0,0) activation vector are stored first, followed by the activations in the (1,0) activation vector, further followed by activations in other activation vectors.

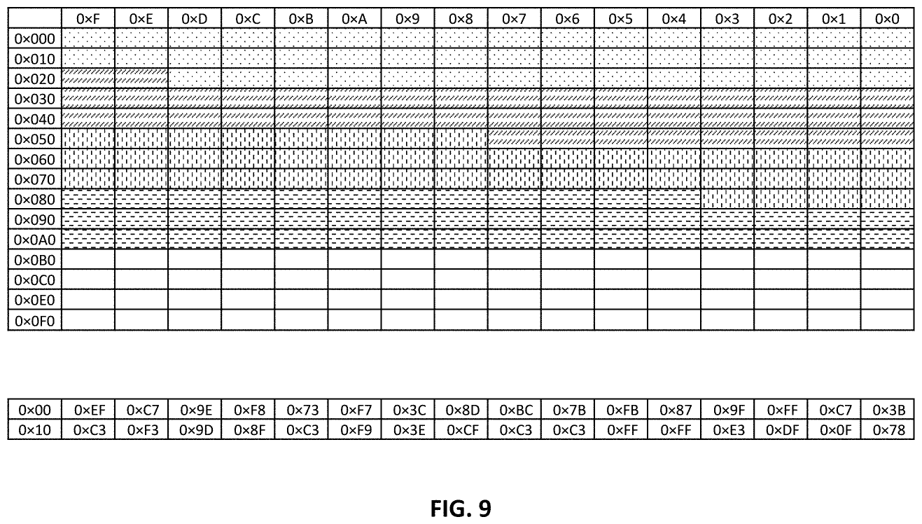

In some embodiments, the activations stored in the external memory 310 may be compressed data, e.g., data compressed by the acceleration module 350 in the DNN accelerator 320. Due to the compression, the activation data stored in the external memory 310 may have less bits than the activation data stored in the local memory 370. In some embodiments, the external memory 310 stores non-sparse activations, i.e., activations having non-zero values, but does not store sparse activations, i.e., activations having zero values. The length of an activation vector stored in the external memory 310 may be less than the number of channels due to the absence of zero valued activations in the external memory 310. The external memory 310 may also store sparsity bitmaps of activation vectors. A sparsity bitmap may indicate positions of non-zero valued activations and positions of zero valued activations. In some embodiments, a sparsity bitmap of an activation vector includes a sequence of bits. Each bit corresponds to a different activation in the activation vector and indicates whether the value of the activation is zero or non-zero. In an example, a bit corresponding to a zero valued activation is zero, and a bit corresponding to a non-zero valued activation is one. The position of a bit in the sparsity bitmap may match the position of the corresponding activation in the activation vector. The number of bits in the sparsity bitmap may equal the number of activations in the activation vector. More details regarding memory layout are provided below in conjunction with FIGS. 9-14.

In addition to activations, the external memory 310 stores weights in one or more filters for the convolution. Weights stored in the external memory 310 may also be compressed data. In some embodiments, the external memory 310 stores non-zero valued weights and may not store zero valued weights. The external memory 310 may also store sparsity bitmaps of weight vectors. A memory layout of weights stored in the external memory 310 may be the same or similar as a memory layout of activations stored in the external memory 310.

The compiler 320 generates data transfer tasks. In some embodiments, the compiler 320 may generate two types of data transfer tasks for transferring activations between the external memory 310 and the local memory 370. A data transfer task of transferring activations from the local memory 370 to the external memory 310 may be referred to as an activation spill out task. A data transfer task of transferring activations from the external memory 310 to the local memory 370 may be referred to as an activation spill in task. The compiler 320 may transmit the data transfer tasks to the DMA engine 340, and the DMA engine 340 may perform the data transfer tasks. In an example, the compiler 320 may transmit a “Spill In” descriptor to the DMA engine 340 for performing an activation spill in task. The compiler 320 may transmit a “Spill Out” descriptor to the DMA engine 340 for performing an activation spill out task.

In some embodiments, the compiler 320 may also instruct the DMA engine 340 to store the size of compressed data to be transferred through a data transfer task. The size of compressed data may be referred to as compressed size. The compressed size may indicate a width of the compressed data, e.g., the total number of bytes in the compressed data. The compressed sized may be stored in the local memory 370. The compressed size may also be referred to as a remote width. In some embodiments, the compiler 320 may allocate a LUT (look-up table) entry and assigns it to the DMA descriptors corresponding to the “Spill out” and “Spill In” data transfer tasks. The LUT entry may have one or more addresses in the local memory 370, and the one or more addresses may be referred to as “LUTAddress.”

For an activation spill out task, the compiler 320 may tag a “Spill Out” descriptor with “Remote Width Store,” which is a bit that enables saving the compressed size at LUTAddress. For an activation spill in task, the compiler 320 may tag the “Spill In” descriptor with “Remote Width Fetch,” which is a bit that enables fetching the compressed size from LUTAddress.

The DNN accelerator 330 executes DNN models, e.g., based on data from the external memory 310 or instructions from the compiler 320. The DNN accelerator 330 includes a DMA engine 340, an acceleration module 350, and a compute block 360 including a local memory 370 and an MAC array 380. In other embodiments, alternative configurations, different or additional components may be included in the DNN accelerator 330. For instance, the DNN accelerator 330 may include more than one DMA engine 340, more than one local memory 370, or more than one MAC array 380. Further, functionality attributed to a component of the DNN accelerator 330 may be accomplished by a different component included in the DNN accelerator 330 or by a different system.

The DMA engine 340 facilitates data transfer between the external memory 310 and the local memory 370 in accordance with instructions from the compiler 320. An instruction from the compiler 320 to the DMA engine 340 may be referred to as a DMA descriptor. The DMA engine 340 may read data from the external memory 310 and write data into the local memory 370. As another example, the DMA engine 340 can read data from the local memory 370 and write data into the external memory 310. The DMA engine 340 provides a DMA feature that allows the compute block 360 to initiate data transfer between the external memory 310 and the local memory 370 and to perform other operations (e.g., operations by the MAC array 380) while the data transfer is in program.

The DMA engine 340 may receive one or more data transfer tasks (e.g., activation spill in tasks or activation spill out tasks) for transferring activations of a convolution. After receiving an activation spill in task, the DMA engine 340 may read activation data from the external memory 310. In embodiments where the activation data is compressed, the DMA engine 340 may receive an instruction from the compiler 320 to read a compressed size of the activation data from an address in the local memory 370. The DMA engine 340 may read the compressed size from the local memory 370 and then use the compressed size to read the activation data from the external memory 310. The DMA engine 340 may transmit the activation data to the acceleration module 350 to decompress the activation data before the activation data is written into the local memory 370.

After receiving an activation spill out task, the DMA engine 340 may read activation data from the local memory 370. The DMA engine 340 may receive an instruction from the compiler 320 to store a compressed size of the activation data at an address in the local memory 370. The DMA engine 340 may transmit the activation data to the acceleration module 350 to compress the activation data. The acceleration module 350 may write the compressed size into the local memory 370 and write the compressed activation data into the external memory 310.

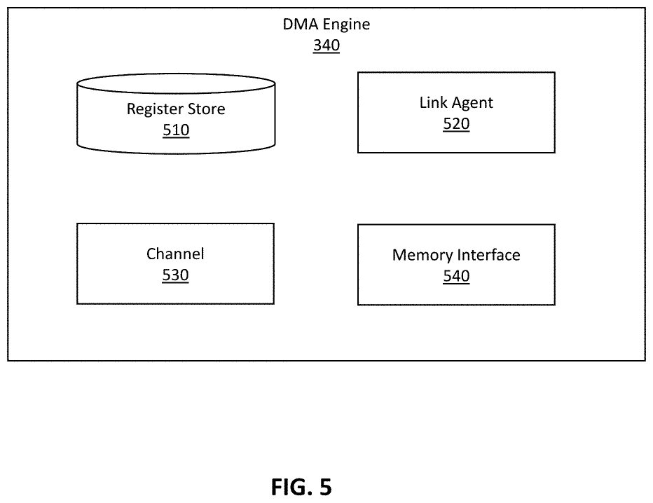

In some embodiments, data transfer tasks may be independent from each other and can be processed by the DMA engine 340 separately. In some embodiments, the DMA engine 340 may process a set of data transfer tasks in accordance with a temporal sequence. For instance, the DMA engine 340 may determine an order in which the data transfer tasks will be processed. The DMA engine 340 may use a first-in-first out (FIFO) method to determine the order. The DMA engine 340 process the first data transfer tasks it received first. Certain aspects of the DMA engine 340 are described below in conjunction with FIG. 5.

The acceleration module 350 includes a compressor 353 and a decompressor 355. The compressor 353 compresses activation data, e.g., activations read by the DMA engine 340 from the local memory 370. In some embodiments, the compressor 353 may compress the activation data based on sparsity. For instance, the compressor 353 may keep non-sparse activations and disregard sparse activation. The compressor 353 may also change the memory layout of the activations, e.g., to reduce the memory footprint. The compressor 353 may also determine a size of compressed activation data and store the compressed size in the local memory 370. The compressor 353 may further compress activation data by using compression algorithms, such as entropy-based compression algorithms. The compression of activation data can save memory bandwidth and result in better performance of the DNN accelerator 330, such as better TOPS/mm² or TOPs/W.

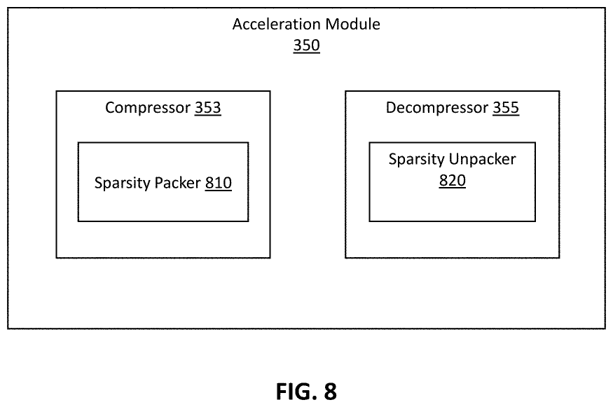

The decompressor 355 decompress activation data, e.g., compressed activation data read by the DMA engine 340 from the external memory 310. In embodiments where the compressor 353 changes the memory layout of activations in the compression process, the decompressor 355 may change it back to the original memory layout of the activations. After the decompression, the decompressor 355 may write the activation data into the local memory 370. Certain aspects of the acceleration module 350 are described below in conjunction with FIG. 8.

The compute block 360 includes the local memory 370 and an MAC array 380. The compute block 360 may be a tile of the DNN accelerator 330 in embodiments where the DNN accelerator 330 has a tile architecture. The DNN accelerator 330 may include one or more other compute blocks that may operate in parallel with the compute block 360.

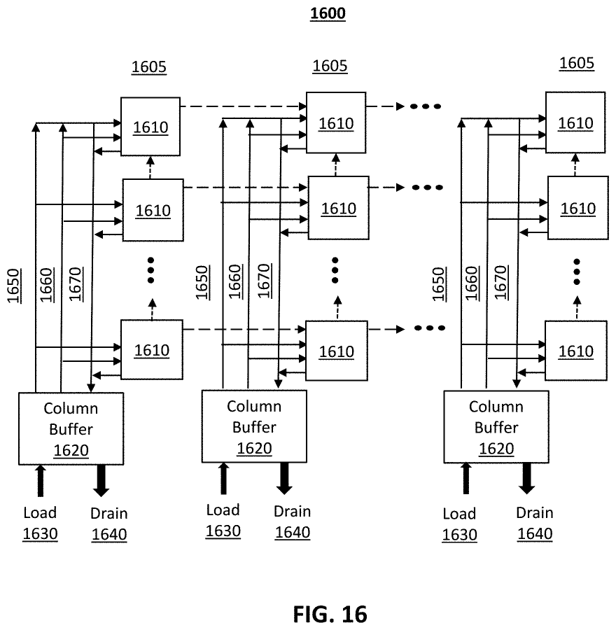

The MAC array 380 performs deep learning operations. Example deep learning operations include convolutions (also referred to as “convolutional operations”), pooling operations, elementwise operations, other types of deep learning operations, or some combination thereof. The MAC array 380 includes a plurality of MAC units. The MAC units may be arranged in columns, or columns and rows. In some embodiments, the MAC array 380 receive an input tensor and a weight tensor of a convolution and performs MAC operations with the input tensor and weight tensor. The result of the MAC operations may be an output tensor, which can be further computed, e.g., by the MAC array 380 or another MAC array. The input tensor, weight tensor, and output tensor may be stored in the local memory 370. More details about MAC array are described below in conjunction with FIG. 16.

The local memory 370 may store data generated by or used by the MAC array 380. The local memory 370 is local to the compute block 360. In the embodiments of FIG. 3, the local memory 370 is inside the compute block 360. In other embodiments, the local memory 370 may be outside the compute block 360. The local memory 370 and the MAC array 380 can be implemented on the same chip. In some embodiments, the local memory 370 includes one or more SRAMs (static random-access memories). The local memory 370 may include one or more buffers, one or more cache memories, one or more register files, or some combination thereof.

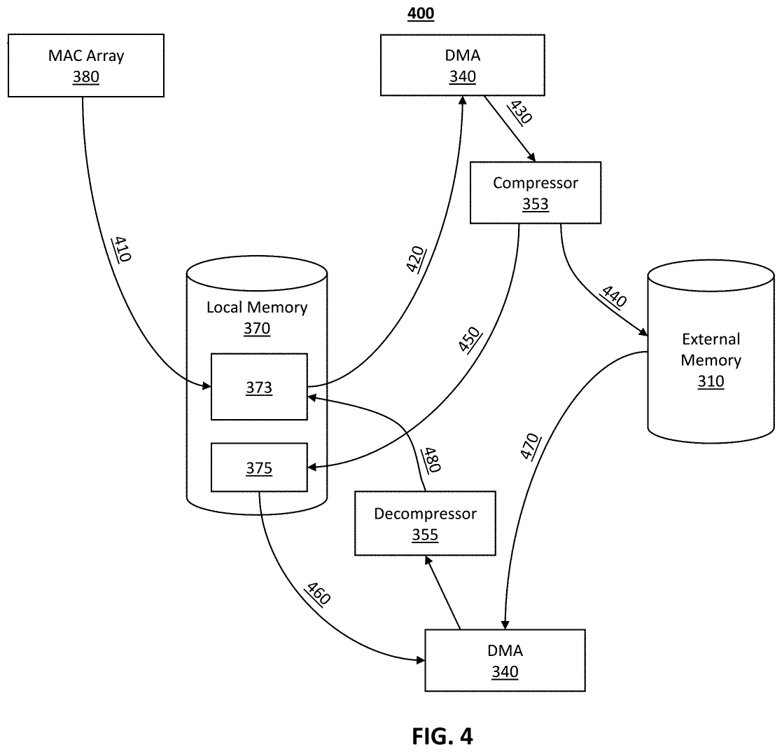

FIG. 4 illustrates an activation spill process 400, in accordance with various embodiments. The activation spill process 400 may be performed by components of the DNN system 300 in FIG. 3. The activation spill process 400 includes an activation spill out process and an activation spill in process. The activation spill out process may be before the activation spill in process. In the embodiments of FIG. 4, the activation spill process 400 includes eight steps: 410, 420, 430, 440, 450, 460, 470, and 480. The steps 410, 420, 430, and 440 may constitute the activation spill out process. The steps 450, 460, 470, and 480 may constitute the activation spill in process. The steps 410, 420, 430, 440, 450, 460, 470, and 480 may be in a temporal order, in which the step 410 is the earliest and the step 480 is the latest.

In the step 410, the MAC array 380 writes activations into the local memory 370. The activations may be computed by the compute block 360, e.g., in one or more deep learning operations, such as convolutions. In the embodiments of FIG. 4, the activations are written into a storage unit 373 in the local memory 370. The storage unit 373 may be a buffer.

In step 420, the DMA engine 340 reads the activations from the storage unit 373. In step 430, the DMA engine 340 transmits the activations to the compressor 353. The compressor 353 may compress the activations and generate compressed activation data. The compressor 353 may also determine a compressed size indicating the number of bytes in the compressed activation data. In step 440, the compressor 353 writes the compressed activation data into the external memory 310. In step 450, the compressor 353 writes the compressed size into the local memory 370, particularly a storage unit 375 in the local memory 370.

In the step 460, the DMA engine 340 reads the compressed size from the storage unit 375. In step 470, the DMA engine 340 reads the compressed activation data from the external memory 310, e.g., based on the compressed size. After the DMA engine 340 receives the compressed activation data from the external memory 310, the DMA engine 340 transmits the compressed activation data to the decompressor 355. The decompressor 355 may decompress the compressed activation data and restore the activations. In the step 480, the decompressor 355 writes the activations into the storage unit 373 of the local memory 370. The MAC array 380 may fetch the activations from the storage unit 373. The MAC array 380 may use the activations as input activations and perform MAC operations on the activations and weights. The MAC array 380 may compute new activations from the MAC operations. The new activations may be stored in the storage unit 373 of the local memory 370. The activation spill process 400 may be performed again for the new activations.

FIG. 5 is a block diagram of the DMA engine 340, in accordance with various embodiments. The DMA engine 340 includes a register store 510, a link agent 520, a channel 530, and a memory interface 540. In other embodiments, alternative configurations, different or additional components may be included in the DMA engine 340. Further, functionality attributed to a component of the DMA engine 340 may be accomplished by a different component included in the DMA engine 340, a different component in the DNN accelerator 330, or by a different system. The DMA engine 340 may be at least partially implemented in hardware. Some functions of the DMA engine 340 may be implemented in software.

The register store 510 stores configuration registers and state registers of the DMA engine 340. In some embodiments, the register store 510 receives configuration registers, e.g., from a compiler, e.g., the compiler 320 in FIG. 3. A configuration register may specify a configuration of the DMA engine 340 for an operation of the DMA engine 340. The configuration registers may provide information of configurations of components of the DMA engine 340, e.g., configurations of the channel 530 or components in the channel 530. For instance, the configuration registers may specify configurations about data buffer, data width, read capacity, write capability, and so on. The register store 510 may provide configuration registers to the channel 530 for the channel 530 to operate in accordance with the configuration registers.

The register store 510 may also receive state registers, e.g., from the channel 530. A state register may specify a status of the DMA engine 340 for an operation of the DMA engine 340. The state registers may provide information of states of components of the DMA engine 340, e.g., states of the channel 530 or components in the channel 530. In an example, a state register may indicate a status of a data path (or a portion of the datapath) in the channel 530. The status may be idle, wait, busy, and so on.

The link agent 520 accesses memory and read task descriptors. The link agent 520 may receive the task descriptors from a compiler, e.g., the compiler 320 in FIG. 3. A task descriptor includes information describing a data transfer tasks. A data transfer task may be a task of reading a data block from a first memory and writing the data block into a second memory. The data block may be stored at an address in the first memory, and the address may be referred to as a read address. The data block may also have a write address, which is an address in the second memory to which the data block will be written. In some embodiments, a read address or write address is associated with a fixed number of bytes. The fixed number may be, for example, 52, 64, or other numbers. The number of bytes in the data block may not exceed the fixed number. The data block may be data to be used by the MAC array 380 for performing a deep learning operation or data that was generated by the MAC array 380 from a deep learning operation performed by the MAC array 380. In an example where the deep learning operation is a convolution, the data block may include one or more weights in a kernel of the convolution, one or more activations in an input tensor of the convolution, one or more activations n an output tensor of the convolution, or some combination thereof.

In some embodiments, the link agent 520 receives a task descriptor for each data transfer task. The link agent 520 reads task descriptors of data transfer tasks. The task descriptor of a data transfer task includes information describing one or more attributes of the data transfer task, such as the size of the data block (e.g., the number of bytes in the data block, etc.) to transfer, the memory address to read the data, the memory address to write the data, and so on. The reading of the task descriptor by the link agent 520 may be referred to as task descriptor fetch. In some embodiments, after the link agent 520 reads the task descriptor, the execution of the data transfer task may be started. The link agent 520 may provide the task descriptor of a data transfer task to the channel 530 for the channel 530 to process the data transfer task.

In some embodiments, the link agent 520 may issue additional memory reads to retrieve a value to be used as a size of data to be transferred. The retrieval of such as value may be referred to as Remote Width Fetch, in which the data transfer width (e.g., the number of bytes) is retrieved from a memory address. The memory address may be included in the task description. The link agent 520 may transmit the task information to the channel 530, and the channel 530 may execute the data transfer task based on the task information. In some embodiments, the Remote Width Fetch is controlled by a bit in the task descriptor. The address to retrieve the remote width may reuse a standard width field of the task description. As the link agent 520 already has hardware support for issuing memory reads so the addition of the remote width support can be negligible with respect to the hardware implementation of the link agent 520.

The channel 530 executes data transfer tasks. For instance, the channel 530 may read data from an address specified in a task descriptor. The channel 530 may also write data to an address specified in a task descriptor. In some embodiments, the channel 530 may store the size of data written to a memory to a specified memory address, which is referred to as Remote Width Store. Remote width store may be enabled on the hardware implementation of the channel 530 by adding support for an additional memory write. The additional memory write may be used to store the width of transferred data. The width may be the number of bytes in the transferred data. The hardware implementation of the channel 530 may already have support for counting the number of bytes written to a memory, which is used by other DMA features. The cost of adding the support for Remote Width Store may be negligible.

In some embodiments, the channel 530 may operate in accordance with configuration registers from the register store 510. The channel 530 may also provide state registers to the register store 510, e.g., as the status of components in the channel 530 changes. The channel 530 may execute a data transfer task based on the task descriptor of the data transfer task. For instance, the data transfer channel may read the data block from the read address specified in the task descriptor and write the data block to the write address specified in the task descriptor. In embodiments where the channel 530 needs to buffer the data block during the execution of the data transfer task, the channel 530 may reserve sufficient storage space in a buffer inside the data transfer channel based on the size of the data block. The channel 530 can execute multiple data transfer tasks in parallel to minimize latency and maximize utilization.

The memory interface 540 facilitates communications of the DMA engine 340 with memories, e.g., the external memory 310 and the local memory 370 in FIG. 3. In some embodiments, the channel 530 may communication with the memories through the memory interface 540. For instance, the channel 530 may send read requests (i.e., requests to read data) to a memory through the memory interface 540. The channel 530 may also send write requests (i.e., requests to write data) to a memory through the memory interface 540. The channel 530 may also receive responses to read or write requests from memories through the memory interface 540.

Even though FIG. 5 shows one memory interface 540, the DMA engine 340 may include multiple memory interfaces 540. For example, the DMA engine 340 may include two memory interfaces 540: one for communicating with the external memory 310, and the other one for communicating with the local memory 370. In another example, the DMA engine 340 may include two memory interfaces 540 for a memory: one for sending requests to the memory and the other one for receiving responses from the memory.

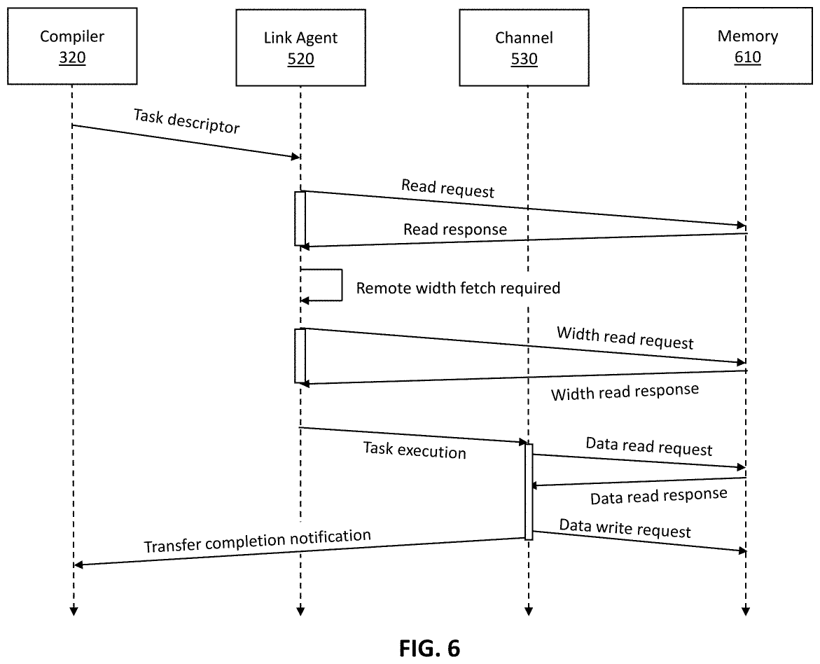

FIG. 6 illustrates data transfer with Remote Width Fetch, in accordance with various embodiments. In FIG. 6, the compiler 320 transmits a task descriptor to the link agent 520. The link agent 520, after receiving the task descriptor, issues a read request to a memory 610. The memory 610 may be the external memory 310, the local memory 370, or a combination of both. The task descriptor may describe a data transfer task, e.g., a task of transferring data from the external memory 310 to the local memory 370. The read request may include an address in the memory 610. The address may be specified in the task descriptor. The memory 610 issues a read response and transmits the read response to the link agent 520.

The link agent 520 also determines that Remote Width Fetch is required for the data transfer task, e.g., based on the Remote Width Fetch bit in the task descriptor. The link agent 520 issues a size read request to the memory 610 (e.g., the local memory 370) for fetching a data width stored in the memory 610. The task descriptor may specific an address where the data width is stored. The memory 610 (e.g., the local memory 370) issues a width read response and transmits the width read response to the link agent 520. The width read response may include the data width.

Further, the link agent 520 sends a task execution request to the channel 530 and requests the channel 530 to execute a data transfer task. The link agent 520 may generate the task execution request based on the read response from the memory 610 and the data width. The channel 530 issues a data read request to the memory 610, e.g., to the external memory 310. The memory 610 issues a read response and transmits the read response to the channel 530. The read response may include the data fetched based on the data width. The channel 530 also issue a data write request to the memory 610 (e.g., the local memory 370) to write the data into the memory 610. After issuing the data write request, the channel 530 transmits a transfer completion notification to the compiler 320 to notify the compiler 320 that the data transfer task is completed.

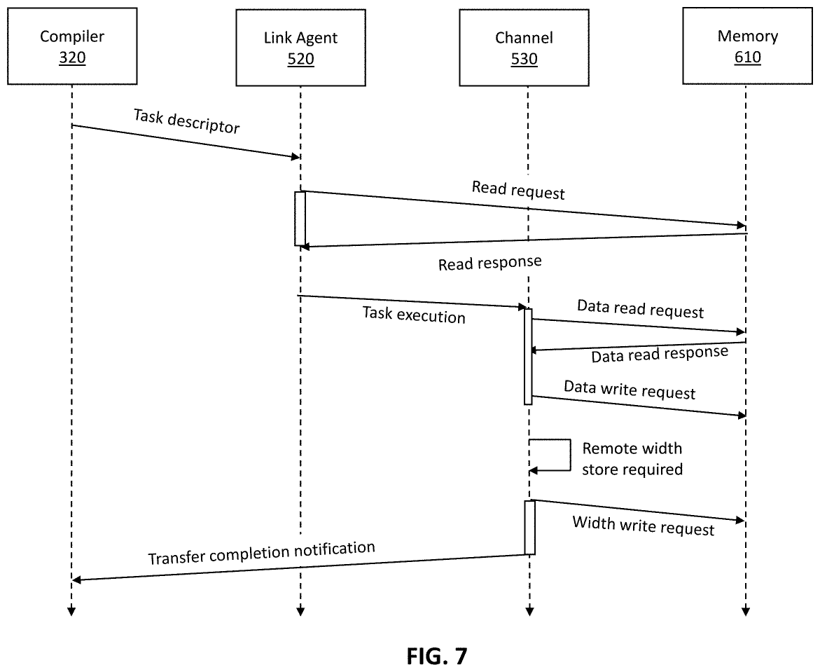

FIG. 7 illustrates data transfer with Remote Width Store, in accordance with various embodiments. In FIG. 7, the compiler 320 transmits a task descriptor to the link agent 520. The task descriptor may describe a data transfer task, e.g., a task of transferring data from the local memory 370 to the external memory 310. The link agent 520, after receiving the task descriptor, issues a read request to a memory 610. The memory 610 issues a read response and transmits the read response to the link agent 520. The link agent 520 may generate a task execution request based on the read response. The link agent 520 sends the task execution request to the channel 530 and requests the channel 530 to execute a data transfer task. The channel 530 issues a data read request to the memory 610, e.g., to the local memory 370. The memory 610 issues a read response and transmits the read response to the channel 530. The read response may include the data stored in the memory 610. The channel 530 further determines that Remote Width Store is required. The channel 530 issues a width write request to the memory 610 (e.g., the local memory 370) to write a data width into the memory 610. After issuing the data write request, the channel 530 transmits a transfer completion notification to the compiler 320 to notify the compiler 320 that the data transfer task is completed.

FIG. 8 is a block diagram of the acceleration module 350, in accordance with various embodiments. The acceleration module 350 can support acceleration of deep learning operations based on sparsity in activation data. In the embodiments of FIG. 8, the compressor 353 in the acceleration module 350 includes a sparsity packer 810, and the decompressor 355 in the acceleration module 350 includes a sparsity unpacker 820.

The sparsity packer 810 may pack sparsity bitmaps with activations. In some embodiments, an activation vector has a sparsity bitmap that indicates positions of zero valued activations and positions of non-zero valued activations in the activation vector. The activations in the activation vector may have the same (x,y) coordinate, which is also the (x,y) coordinate of the activation vector. Sparsity bitmaps and activation vectors may be stored separately in the local memory 370. In an example, the sparsity bitmaps and activation vectors may be stored in separate sections or separate data storage units in the local memory 370.

FIG. 9 illustrates a memory layout where activation vectors and sparsity bitmaps are stored separately, in accordance with various embodiments. The highlighted cells in FIG. 9 represent addresses where non-zero activations are stored. There are four activation vectors in the memory layout, and each activation vector is represented by a different highlight pattern. In other embodiments, the memory layout may include a different number of activation vectors.

The activation vectors are stored at a section showing as addresses 0x000 to 0x0A0 in FIG. 9, versus the sparsity bitmaps of the activation vectors are stored at a second section (e.g., a buffer which may be designated for storing sparsity bitmaps) showing as addresses 0x00 to 0x10 in FIG. 9. Each pattern represents an activation vector. The activation vectors are stored consecutively in FIG. 9, i.e., the last non-zero valued activation of an activation vector is stored right before the first non-zero valued activation of the next activation vector. With such a memory layout, it is hard to identify the start or end of an activation vector, as the numbers of non-zero valued activations in different activation vectors can be different. The memory layout in FIG. 9 may require the MAC array 380 to buffer the non-zero valued activations in the first activation vector before the first activation vector can be written into the local memory 370. The buffering can be costly as the storage capacity of the buffer needs to be large enough to store the activation vector having the most the non-zero valued activations. Such buffering cost can impair both the TOPs/mm² and TOPs/W metric of the DNN accelerator 330.

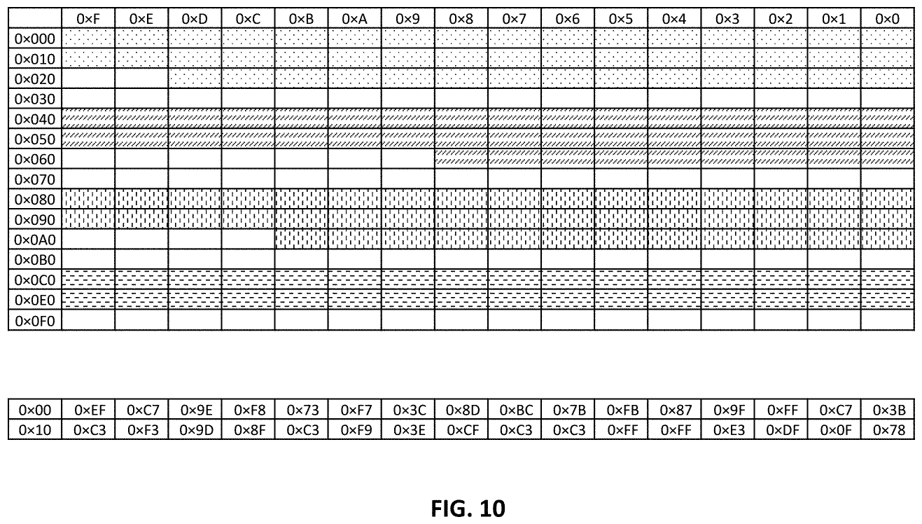

FIG. 10 illustrates another memory layout where activation vectors and sparsity bitmaps are stored separately, in accordance with various embodiments. The highlighted cells in FIG. 10 represent addresses where non-zero activations are stored. There are four activation vectors in the memory layout, and each activation vector is represented by a different highlight pattern.

In FIG. 10, even though the activation vectors and sparsity bitmaps are stored separately, the activation vectors are not stored consecutively. There are empty bytes between the last non-zero valued activation of an activation vector and the first non-zero valued activation of the next activation vector. The start of each activation vector may be deterministic and depend on the static tensor size. Each activation vector may start at its own offset address in the memory. The address of the first non-zero valued activation of each activation vector can be determined, and the start of every activation vector can be known. Such a memory layout may avoid the buffering cost required by the memory layout in FIG. 9. However, the memory layout in FIG. 10 requires a bigger memory layout and the usage of storage space in the memory is not maximized. Also, to save memory bandwidth and energy cost, the unhighlighted memory addresses in FIG. 10 between activation vector may not be written, but rather have persistent data, e.g., data from previous deep learning operations. The compression efficiency can be low as the persistent data in memory may be data (e.g., activations, weights, or both) from previous layers and may not be deterministically compressible. There is, however, the need for deterministic compression based on the sparsity of the activations to achieve a higher compression efficiency.

To solve at least this problem, the sparsity packer 810 in FIG. 8 may read a sparsity bitmap of an activation vector and read the activation vector. The sparsity packer 810 may then form a data package that includes the sparsity bitmap and the activation vector. In some embodiments, the data package may include non-zero valued activations in the activation vector but may exclude zero valued activations in the activation vector. The sparsity bitmap may be placed in front of the activation vector in the data package. The sparsity packer 810 may continue to form another data package that includes another pair of sparsity bitmap and activation vector. In some embodiments, the sparsity packer 810 may form a sequence of data packages. The order of the data packages in the sequence may be determined based on the (x,y) coordinates of the activation vectors in the data packages.

FIG. 11 illustrates a memory layout including consecutive data packages, each of which includes a sparsity bitmap and an activation vector, in accordance with various embodiments. The highlighted cells in FIG. 11 represent addresses where non-zero activations are stored. There are four activation vectors in the memory layout, and each activation vector is represented by a different highlight pattern. The activation vectors are stored in an order that may be determined based on the (x,y) coordinates of the activation vectors. In an example, the (x,y) coordinate of the first activation vector (i.e., the activation vector stored at the addresses highlighted with the dotted pattern) is (0,0), the (x,y) coordinate of the second activation vector (i.e., the activation vector stored at the addresses highlighted with the slash pattern) is (1,0), the (x,y) coordinate of the third activation vector (i.e., the activation vector stored at the addresses highlighted with the vertical strip pattern) is (0,1), and the (x,y) coordinate of the fourth activation vector (i.e., the activation vector stored at the addresses highlighted with the horizontal strip pattern) is (1,1).

As shown in FIG. 11, the data packages are stored consecutively. For instance, the last byte of a first data package may be right before the first byte of the second data package in the memory layout. Compared with the memory layout in FIG. 10, the memory layout in FIG. 11 can reduce the memory footprint and improve memory usage. However, it can make it harder for the sparsity unpacker 820 to identify the start of the second data package. The unpacking logic may be complicated, which can be challenging in terms of silicon area and attaining higher frequencies.

Referring back to FIG. 8, the sparsity packer 810 may generate a value that indicates a length of an activation vector. The length of the activation vector may be the number of stored activations (e.g., non-zero valued activations) in the activation vector. The value may be referred to as a header. The sparsity packer 810 may include the header in the data package of the activation vector and place the header right before the activation vector. In some embodiments, the header may be placed between the sparsity bitmap and the activation vector. The header may include one or more bytes. The number of bytes in the header may be determined on the number of activations following the header, i.e., the number of stored activations in the activation vector. The generation of the header may require additional encoding overhead, but the unpacking logic can be less complicated as the start of the second data package can be determined based on the header. Thus, the silicon cost and frequency constraints can be reduced.

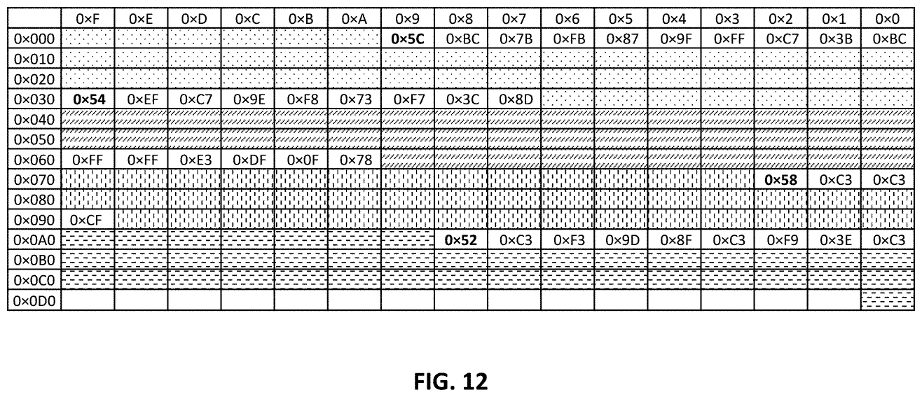

FIG. 12 illustrates a memory layout including consecutive data packages, each of which includes a sparsity bitmap, a header, and a sequence of activations, in accordance with various embodiments. The headers in the data packages are bolded in FIG. 12. As shown in FIG. 12, the four data packages are store consecutively. Each data package includes a sparsity bitmap of an activation vector, followed by a header, further followed by non-zero valued activations in the activation vector. The last byte of a data package is right before the first byte of the next data package.

Referring back to FIG. 8, the sparsity packer 810 may add a zeropoint at the end of each activation vector in other embodiments, e.g., embodiments where zero valued activations are not stored. As the stored activations have non-zero values, there may be no zero values other than the zeropoint. The boundary between two adjacent activation vectors may be identified by detection of the zeropoint. An activation vector and a zeropoint may form a data package in the memory layout. The data package may or may not include the sparsity map of the data package.

In some embodiments, it may save more memory space to use zeropoint markers than header in data packages, as the zeropoint marker may have the same number of bits for all activation vectors, versus the headers of different activation vectors may include different numbers of bits as different activation vectors may have different lengths. In an example where the data format is INT8, a zeropoint marker may have eight bits (i.e., one byte), versus a header may have more than one byte. In other embodiments, it may save more memory space to use headers than zeropoint markers. In an example where the data format is FP 16 or BP16, a zeropoint marker may have two bytes, versus a header may have one byte.

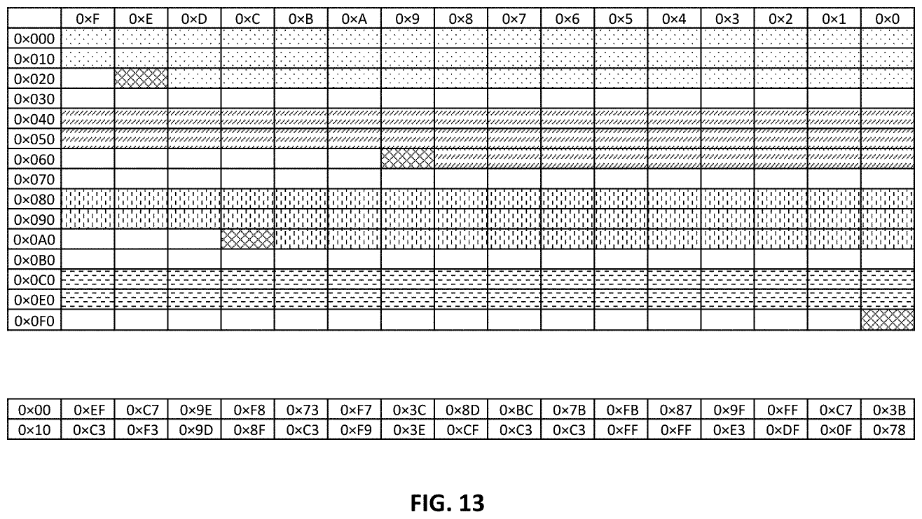

FIG. 13 illustrates a memory layout including sequential data packages, each of which includes a sequence of activations and a zeropoint marker, in accordance with various embodiments. A zeropoint marker is a data element or a datapoint that has a zero value. The activations in a data package may be non-zero valued activations of an activation vector. As the activations in the memory layout are non-zero values. The zeropoint markers can constitutes as markers of boundaries of the data packages, and the start of an activation vector may be identified by the detection of a zeropoint marker. In the memory layout in FIG. 13, the data packages are stored sequentially, but not consecutively, and therefore, the memory footprint is not minimized.

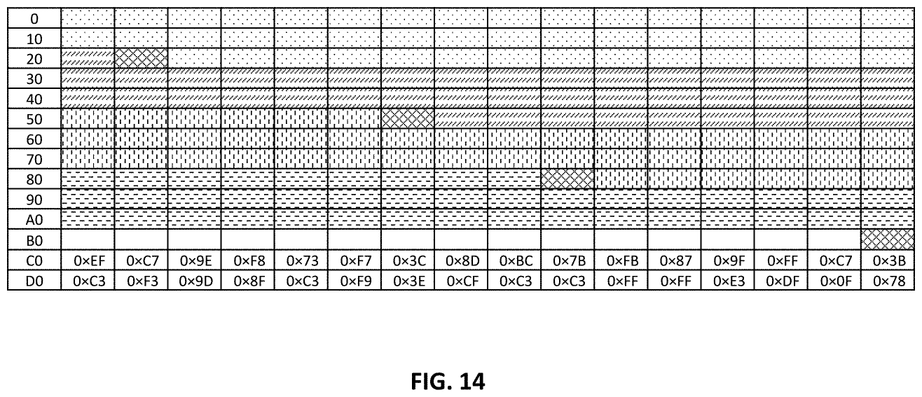

FIG. 14 illustrates a memory layout including sequential, consecutive data packages, each of which includes a sequence of activations and a zeropoint, in accordance with various embodiments. The data packages in FIG. 14 may be the same as the data packages in FIG. 13. However, the data packages are stored consecutively in FIG. 14. The zeropoint in a data package is right before the first activation in the next data package. Thus, the memory footprint in FIG. 14 is smaller than the memory footprint in FIG. 13.

The activations and sparsity bitmaps are stored separately in FIGS. 13 and 14. The sparsity packer 810, instead of relying on the sparsity bitmaps to discard invalid bytes, may use the zeropoint markers to identify the valid to invalid element boundary and discard them and pack only the valid bytes with the zeropoint marker preserved. The sparsity bitmap may spill out to the external memory 310 through a separate data transfer task. The sparsity packer 810 may not read the sparsity bitmaps to form the data packages, which can lead to a simpler implementation. In other embodiments, a data package may also include the sparsity bitmap. For instance, the sparsity bitmap may be placed in front of the activations, between the activations and the zeropoint, or placed after the zeropoint in the data package.

Referring back to FIG. 8, after the sparsity packer 810 forms the data packages (e.g., the data packages shown in FIGS. 11-14), the compressor 353 may compress the data packages. The compressor 353 may use various compression techniques to compress data packages. In an example, the compressor 353 may use a lossless data compression method, e.g., entropy coding. In other embodiments, the compressor 353 may use other types of coding to compress data packages. The compressor 353 may write the compressed data packages into a memory, e.g., the external memory 310. The compressor 353 may also determine a size of the compressed data packages, or a size of a singled compressed data package. The compressor 353 may store the size in a memory, e.g., the local memory 370.

The sparsity unpacker 820 unpacks compressed data packages. A compressed data package may be read from the external memory by the DMA engine 340. The DMA engine 340 may transmit the compressed data package to the decompressor 355 for decompressing the compressed data package. After the decompression, the sparsity unpacker 820 may unpack the data package. In an example where a data package includes a zeropoint marker (e.g., a data package shown in FIG. 14), the sparsity unpacker 820 may search for the zeropoint marker and restore the sparse tensor, e.g., the sparse tensor shown in FIG. 13 where there are empty addresses between data packages.

Example Method of Deep Learning

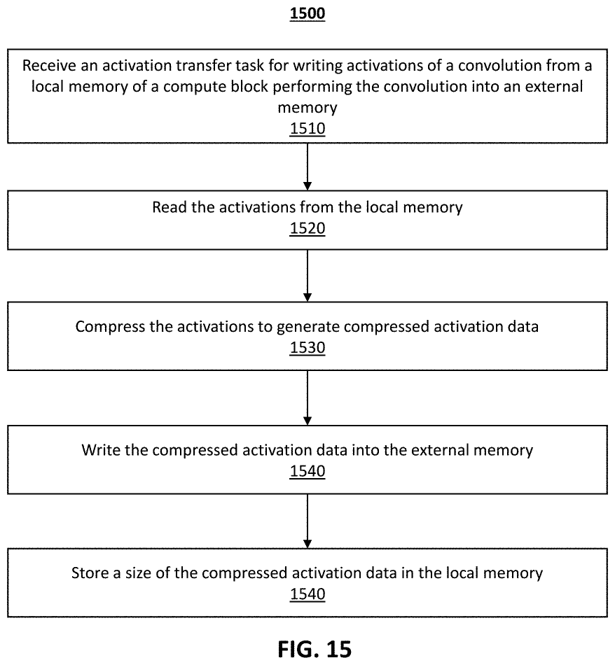

FIG. 15 is a flowchart showing a method 1500 of deep learning, in accordance with various embodiments. The method 1500 may be performed by the DNN accelerator 330 in FIG. 3. Although the method 1500 is described with reference to the flowchart illustrated in FIG. 15, many other methods for deep learning may alternatively be used. For example, the order of execution of the steps in FIG. 15 may be changed. As another example, some of the steps may be changed, eliminated, or combined.

The DNN accelerator 330 receives an activation transfer task for writing activations of a convolution from a local memory of a compute block performing the convolution into an external memory. In some embodiments, the DNN accelerator 330 receives the activation transfer task from a compiler associated with the DNN accelerator 330.

The DNN accelerator 330 reads 1520 the activations from the local memory. The activations may be computed by the compute block, e.g., by a MAC array in the compute block. The activations may be output activations in an output tensor of the convolution. The convolution may be from a convolutional layer of a DNN. The activations may be used as input data in another convolutional layer of the DNN.

The DNN accelerator 330 compresses 1530 the activations to generate compressed activation data. In some embodiments, the compressed activation data includes non-zero valued activations in a plurality of activation vectors and sparsity bitmaps of the plurality of activation vectors. Each activation vector includes a sequence of activations corresponding to different channels of the convolution. Each sparsity bitmap corresponds to a respective activation vector of the plurality of activation vectors and includes a sequence of bits, each of which corresponds to an activation in the respective activation vector and indicates whether the activation has a zero value or non-zero value.

In some embodiments, the DNN accelerator 330 compresses the activations to generate compressed activation data by forming a plurality of data packages from the non-zero valued activations and the sparsity bitmaps. Each data package includes a sparsity bitmap and non-zero valued activations in an activation vector corresponding to the sparsity bitmap. In some embodiments, each data package further includes a header that indicates a number of the non-zero valued activations in the activation vector. The header is arranged between the sparsity bitmap and the non-zero valued activations in the activation vector.

In some embodiments, the plurality of activation vector includes a first activation vector and a second activation vector. Non-zero valued activations of the first activation vector are arranged before non-zero valued activations of the second activation vector. The compressed activation data further includes a zero valued datapoint between the non-zero valued activations of the first activation vector and the non-zero valued activations of the second activation vector.

The DNN accelerator 330 writes 1540 the compressed activation data into the external memory. In some embodiments, the compressed activation data has a memory layout in the external memory. In the memory layout, activation vectors may be stored in an order, e.g., an order determined based on (X,Y) coordinates of the activation vectors. The activation vectors may be stored consecutively or discretely.

The DNN accelerator 330 stores 1550 a size of the compressed activation data in the local memory. In some embodiments, the size of the compressed activation data indicates a number of bytes in the compressed activation data. In some embodiments, the activations are stored in a first storage unit in the local memory, and the size of the compressed activation data is stored in a second storage unit in the local memory.

In some embodiments, the DNN accelerator 330 receives another activation transfer task for writing the activations from the external memory into the local memory. The DNN accelerator 330 reads the size of the compressed activation data from the local memory and reads the compressed activation data from the external memory based on the size of the compressed activation data. The DNN accelerator 330 decompresses the compressed activation data to restore the activations. The DNN accelerator 330 writes the activations into the local memory. In some embodiments, the DNN accelerator 330 reads the compressed activation data from the external memory after reading the size of the compressed activation data from the local memory.

Example MAC Array

FIG. 16 illustrates an example MAC array 1600, in accordance with various embodiments. The MAC array 1600 is an embodiment of the MAC array 380 in FIG. 3. The MAC array 1600 includes a plurality of MAC units 1610 (individually referred to as “MAC unit 1610”). The MAC units 1610 perform MAC operations, such as integer MAC operations, floating-point MAC operations, and so on. The MAC units 1610 may also be referred to as neurons or nodes in the DNN. Each MAC unit 1610 has 2 input signals 1650 and 1660 and an output signal 1670. The input signal 1650 is at least a portion of an input tensor of a convolution. The input signal 1660 is at least a portion of a filter of the convolution. In some embodiments, the input signal 1650 of a MAC unit 1610 includes one or more input operands, and the input signal 1660 includes one or more weight operands.

Each MAC unit 1610 performs an MAC operation on the input signals 1650 and 1660 and outputs the output signal 1670, which is a result of the MAC operation. Some or all of the input signals 1650 and 1660 and the output signal 1670 may be in an integer format, such as INT8, or floating-point format, such as FP16 or BF16. For purpose of simplicity and illustration, the input signals and output signal of all the MAC units 1610 have the same reference numbers, but the MAC units 1610 may receive different input signals and output different output signals from each other. Also, a MAC unit 1610 may be different from another MAC unit 1610, e.g., including more, fewer, or different components. A MAC unit 1610 may include one or more multipliers and one or more adders.

As shown in FIG. 16, the MAC units 1610 are connected to each other, as indicated by the dash arrows in FIG. 16. The output signal 1670 of an MAC unit 1610 may be sent to many other MAC units 1610 (and possibly back to itself) as input signals via the interconnections between MAC units 1610. In some embodiments, the output signal 1670 of an MAC unit 1610 may incorporate the output signals of one or more other MAC units 1610 through an accumulate operation of the MAC unit 1610 and generate an internal partial sum of the MAC array. Certain aspects of the MAC units 1610 are described below in conjunction with FIG. 5.

In the embodiments of FIG. 16, the MAC units 1610 are arranged into columns 1605 (individually referred to as “column 1605” or “MAC column 1605”). The input and weights of the layer may be distributed to the MAC units 1610 based on the columns 1605. Each column 1605 has a column buffer 1620. The column buffer 1620 stores data provided to the MAC units 1610 in the column 1605 for a short amount of time. The column buffer 1620 may also store data output by the last MAC unit 1610 in the column 1605. The output of the last MAC unit 1610 may be a sum of the MAC operations of all the MAC units 1610 in the column 1605, which is a column-level internal partial sum of the MAC array 1600. In other embodiments, input and weights may be distributed to the MAC units 1610 based on rows in the MAC array 1600. The MAC array 1600 may include row buffers in lieu of column buffers 1620. A row buffer may store input signals of the MACs in the corresponding row and may also store a row-level internal partial sum of the MAC array 1600.

As shown in FIG. 16, each column buffer 1620 is associated with a load 1630 and a drain 1640. The data provided to the column 1605 is transmitted to the column buffer 1620 through the load 1630, e.g., through upper memory hierarchies, e.g., a memory external to the compute tile. The data generated by the column 1605 is extracted from the column buffers 1620 through the drain 1640. In some embodiments, data extracted from a column buffer 1620 is sent to upper memory hierarchies, e.g., a memory external to the compute tile, through the drain operation. In some embodiments, the drain operation does not start until all the MAC units 1610 in the column 1605 have finished their MAC operations.

Example Deep Learning Environment

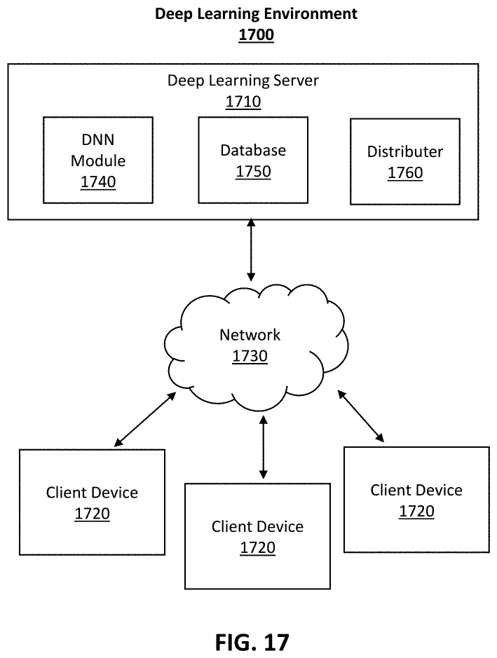

FIG. 17 illustrates a deep learning environment 1700, in accordance with various embodiments. The deep learning environment 1700 includes a deep learning server 1710 and a plurality of client devices 1720 (individually referred to as client device 1720). The deep learning server 1710 is connected to the client devices 1720 through a network 1730. In other embodiments, the deep learning environment 1700 may include fewer, more, or different components.

The deep learning server 1710 trains deep learning models using neural networks. A neural network is structured like the human brain and consists of artificial neurons, also known as nodes. These nodes are stacked next to each other in 3 types of layers: input layer, hidden layer(s), and output layer. Data provides each node with information in the form of inputs. The node multiplies the inputs with random weights, sums them up, and adds a bias. Finally, nonlinear functions, also known as activation functions, are applied to determine which neuron to fire. The deep learning server 1710 can use various types of neural networks, such as DNN, recurrent neural network (RNN), generative adversarial network (GAN), long short-term memory network (LSTMN), and so on. During the process of training the deep learning models, the neural networks use unknown elements in the input distribution to extract features, group objects, and discover useful data patterns. The deep learning models can be used to solve various problems, e.g., making predictions, classifying images, and so on. The deep learning server 1710 may build deep learning models specific to particular types of problems that need to be solved. A deep learning model is trained to receive an input and outputs the solution to the particular problem.

In FIG. 17, the deep learning server 1710 includes a DNN module 1740, a database 1750, and a distributer 1760. The DNN module 1740 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the DNN 100 described above in conjunction with FIG. 1. In some embodiments, the DNN module 1740 trains DNNs through knowledge distillation, e.g., dense-connection based knowledge distillation. The trained DNNs may be used on low memory systems, like mobile phones, IOT edge devices, and so on. An embodiment of the DNN module 1740 is the DNN accelerator 330 described above in conjunction with FIG. 3.

The database 1750 stores data received, used, generated, or otherwise associated with the deep learning server 1710. For example, the database 1750 stores a training dataset that the DNN module 1740 uses to train DNNs. In an embodiment, the training dataset is an image gallery that can be used to train a DNN for classifying images. The training dataset may include data received from the client devices 1720. As another example, the database 1750 stores hyperparameters of the neural networks built by the deep learning server 1710.

The distributer 1760 distributes deep learning models generated by the deep learning server 1710 to the client devices 1720. In some embodiments, the distributer 1760 receives a request for a DNN from a client device 1720 through the network 1730. The request may include a description of a problem that the client device 1720 needs to solve. The request may also include information of the client device 1720, such as information describing available computing resource on the client device. The information describing available computing resource on the client device 1720 can be information indicating network bandwidth, information indicating available memory size, information indicating processing power of the client device 1720, and so on. In an embodiment, the distributer may instruct the DNN module 1740 to generate a DNN in accordance with the request. The DNN module 1740 may generate a DNN based on the information in the request. For instance, the DNN module 1740 can determine the structure of the DNN and/or train the DNN in accordance with the request.

In another embodiment, the distributer 1760 may select the DNN from a group of pre-existing DNNs based on the request. The distributer 1760 may select a DNN for a particular client device 1720 based on the size of the DNN and available resources of the client device 1720. In embodiments where the distributer 1760 determines that the client device 1720 has limited memory or processing power, the distributer 1760 may select a compressed DNN for the client device 1720, as opposed to an uncompressed DNN that has a larger size. The distributer 1760 then transmits the DNN generated or selected for the client device 1720 to the client device 1720.

In some embodiments, the distributer 1760 may receive feedback from the client device 1720. For example, the distributer 1760 receives new training data from the client device 1720 and may send the new training data to the DNN module 1740 for further training the DNN. As another example, the feedback includes an update of the available computing resource on the client device 1720. The distributer 1760 may send a different DNN to the client device 1720 based on the update. For instance, after receiving the feedback indicating that the computing resources of the client device 1720 have been reduced, the distributer 1760 sends a DNN of a smaller size to the client device 1720.

The client devices 1720 receive DNNs from the distributer 1760 and applies the DNNs to perform machine learning tasks, e.g., to solve problems or answer questions. In various embodiments, the client devices 1720 input images into the DNNs and use the output of the DNNs for various applications, e.g., visual reconstruction, augmented reality, robot localization and navigation, medical diagnosis, weather prediction, and so on. A client device 1720 may be one or more computing devices capable of receiving user input as well as transmitting and/or receiving data via the network 1730. In one embodiment, a client device 1720 is a conventional computer system, such as a desktop or a laptop computer. Alternatively, a client device 1720 may be a device having computer functionality, such as a personal digital assistant (PDA), a mobile telephone, a smartphone, an autonomous vehicle, or another suitable device. A client device 1720 is configured to communicate via the network 1730. In one embodiment, a client device 1720 executes an application allowing a user of the client device 1720 to interact with the deep learning server 1710 (e.g., the distributer 1760 of the deep learning server 1710). The client device 1720 may request DNNs or send feedback to the distributer 1760 through the application. For example, a client device 1720 executes a browser application to enable interaction between the client device 1720 and the deep learning server 1710 via the network 1730. In another embodiment, a client device 1720 interacts with the deep learning server 1710 through an application programming interface (API) running on a native operating system of the client device 1720, such as IOS® or ANDROID™.

In an embodiment, a client device 1720 is an integrated computing device that operates as a standalone network-enabled device. For example, the client device 1720 includes display, speakers, microphone, camera, and input device. In another embodiment, a client device 1720 is a computing device for coupling to an external media device such as a television or other external display and/or audio output system. In this embodiment, the client device 1720 may couple to the external media device via a wireless interface or wired interface (e.g., an HDMI (High-Definition Multimedia Interface) cable) and may utilize various functions of the external media device such as its display, speakers, microphone, camera, and input devices. Here, the client device 1720 may be configured to be compatible with a generic external media device that does not have specialized software, firmware, or hardware specifically for interacting with the client device 1720.

The network 1730 supports communications between the deep learning server 1710 and client devices 1720. The network 1730 may comprise any combination of local area and/or wide area networks, using both wired and/or wireless communication systems. In one embodiment, the network 1730 may use standard communications technologies and/or protocols. For example, the network 1730 may include communication links using technologies such as Ethernet, 17010.11, worldwide interoperability for microwave access (WiMAX), 3G, 4G, code division multiple access (CDMA), digital subscriber line (DSL), etc. Examples of networking protocols used for communicating via the network 1730 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 1730 may be represented using any suitable format, such as hypertext markup language (HTML) or extensible markup language (XML). In some embodiments, all or some of the communication links of the network 1730 may be encrypted using any suitable technique or techniques.

Example DNN System

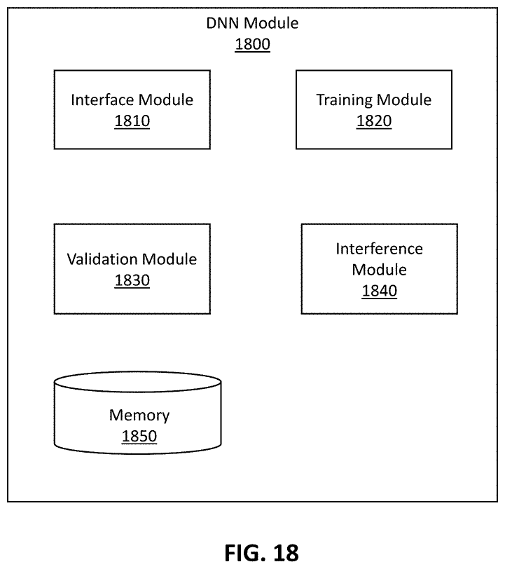

FIG. 18 is a block diagram of an example DNN module 1800, in accordance with various embodiments. The whole DNN module 1800 or a part of the DNN module 1800 may be implemented in the computing device 1400 in FIG. 14. The DNN module 1800 trains DNNs for various tasks, such as image classification, learning relationships between biological cells (e.g., DNA, proteins, etc.), control behaviors for devices (e.g., robots, machines, etc.), and so on. The DNN module 1800 includes an interface module 1810, a training module 1820, a validation module 1830, an inference module 1840, and a memory 1850. In other embodiments, alternative configurations, different or additional components may be included in the DNN module 1800. Further, functionality attributed to a component of the DNN module 1800 may be accomplished by a different component included in the DNN module 1800 or a different system. The DNN module 1800 or a component of the DNN module 1800 (e.g., the training module 1820 or inference module 1840) may include the computing device 1400.

The interface module 1810 facilitates communications of the DNN module 1800 with other systems. For example, the interface module 1810 establishes communications between the DNN module 1800 with an external database to receive data that can be used to train DNNs or input into DNNs to perform tasks. As another example, the interface module 1810 supports the DNN module 1800 to distribute DNNs to other systems, e.g., computing devices configured to apply DNNs to perform tasks.

The training module 1820 trains DNNs by using a training dataset. The training module 1820 forms the training dataset. In an embodiment where the training module 1820 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validation module 1830 to validate performance of a trained DNN. The portion of the training dataset not including the tuning subset and the validation subset may be used to train the DNN.

The training module 1820 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 18, 180, 500, 1800, or even larger.

The training module 1820 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between 2 convolution layers. A fully connected layer involves weights, biases, and neurons. It connects neurons in one layer to neurons in another layer. It is used to classify images between different category by training.

In the process of defining the architecture of the DNN, the training module 1820 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 1820 defines the architecture of the DNN, the training module 1820 inputs a training dataset into the DNN. The training dataset includes a plurality of training samples. An example of a training sample includes an object in an image and a ground-truth label of the object. The training module 1820 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 1820 uses a cost function to minimize the error.

The training module 1820 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 1820 finishes the predetermined number of epochs, the training module 1820 may stop updating the parameters in the DNN. The DNN having the updated parameters is referred to as a trained DNN.

The validation module 1830 verifies accuracy of trained DNNs. In some embodiments, the validation module 1830 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 1830 may determine an accuracy score measuring the precision, recall, or a combination of precision and recall of the DNN. The validation module 1830 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 1830 may compare the accuracy score with a threshold score. In an example where the validation module 1830 determines that the accuracy score of the augmented model is lower than the threshold score, the validation module 1830 instructs the training module 1820 to re-train the DNN. In one embodiment, the training module 1820 may iteratively re-train the DNN until the occurrence of a stopping condition, such as the accuracy measurement indication that the DNN may be sufficiently accurate, or a number of training rounds having taken place.

The inference module 1840 applies the trained or validated DNN to perform tasks. For instance, the inference module 1840 inputs images into the DNN. The DNN outputs classifications of objects in the images. As an example, the DNN may be provisioned in a security setting to detect malicious or hazardous objects in images captured by security cameras. As another example, the DNN may be provisioned to detect objects (e.g., road signs, hazards, humans, pets, etc.) in images captured by cameras of an autonomous vehicle. The input to the DNN may be formatted according to a predefined input structure mirroring the way that the training dataset was provided to the DNN. The DNN may generate an output structure which may be, for example, a classification of the image, a listing of detected objects, a boundary of detected objects, or the like. In some embodiments, the inference module 1840 distributes the DNN to other systems, e.g., computing devices in communication with the DNN module 1800, for the other systems to apply the DNN to perform the tasks.

The memory 1850 stores data received, generated, used, or otherwise associated with the DNN module 1800. For example, the memory 1850 stores the datasets used by the training module 1820 and validation module 1830. The memory 1850 may also store data generated by the training module 1820 and validation module 1830, such as the hyperparameters for training DNNs, internal parameters of trained DNNs (e.g., values of tunable parameters of activation functions, such as Fractional Adaptive Linear Units (FALUs)), etc. In the embodiment of FIG. 18, the memory 1850 is a component of the DNN module 1800. In other embodiments, the memory 1850 may be external to the DNN module 1800 and communicate with the DNN module 1800 through a network.

Example Computing Device

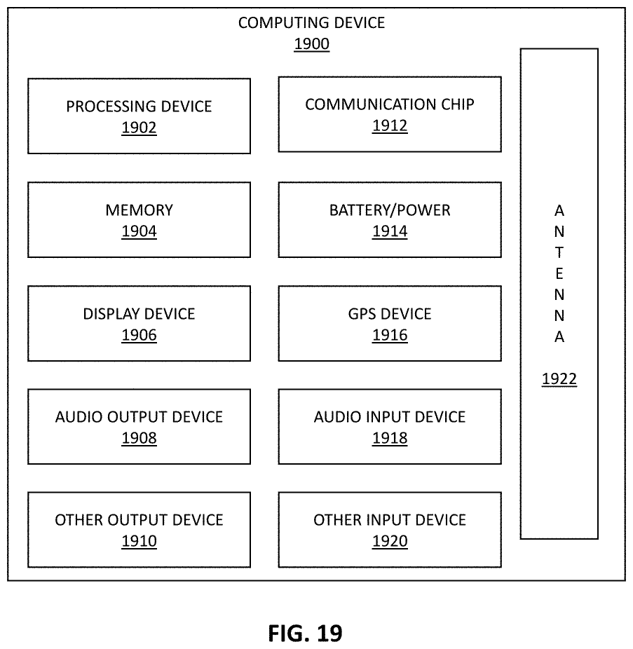

FIG. 19 is a block diagram of an example computing device 1900, in accordance with various embodiments. In some embodiments, the computing device 1900 can be used as the DNN system 1300 in FIG. 13. A number of components are illustrated in FIG. 19 as included in the computing device 1900, but any one or more of these components may be omitted or duplicated, as suitable for the application. In some embodiments, some or all of the components included in the computing device 1900 may be attached to one or more motherboards. In some embodiments, some or all of these components are fabricated onto a single system on a chip (SoC) die. Additionally, in various embodiments, the computing device 1900 may not include one or more of the components illustrated in FIG. 19, but the computing device 1900 may include interface circuitry for coupling to the one or more components. For example, the computing device 1900 may not include a display device 1906, but may include display device interface circuitry (e.g., a connector and driver circuitry) to which a display device 1906 may be coupled. In another set of examples, the computing device 1900 may not include an audio input device 1918 or an audio output device 1908, but may include audio input or output device interface circuitry (e.g., connectors and supporting circuitry) to which an audio input device 1918 or audio output device 1908 may be coupled.

The computing device 1900 may include a processing device 1902 (e.g., one or more processing devices). The processing device 1902 processes electronic data from registers and/or memory to transform that electronic data into other electronic data that may be stored in registers and/or memory. The computing device 1900 may include a memory 1904, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1904 may include memory that shares a die with the processing device 1902. In some embodiments, the memory 1904 includes one or more non-transitory computer-readable media storing instructions executable to perform operations for deep learning, e.g., the method 1500 described above in conjunction with FIG. 15 or some operations performed by the DNN accelerator 330 described above in conjunction with FIG. 3. The instructions stored in the one or more non-transitory computer-readable media may be executed by the processing device 1902.

In some embodiments, the computing device 1900 may include a communication chip 1912 (e.g., one or more communication chips). For example, the communication chip 1912 may be configured for managing wireless communications for the transfer of data to and from the computing device 1900. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1912 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1912 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1912 may operate in accordance with other wireless protocols in other embodiments. The computing device 1900 may include an antenna 1922 to facilitate wireless communications and/or to receive other wireless communications (such as AM or FM radio transmissions).

In some embodiments, the communication chip 1912 may manage wired communications, such as electrical, optical, or any other suitable communication protocols (e.g., the Ethernet). As noted above, the communication chip 1912 may include multiple communication chips. For instance, a first communication chip 1912 may be dedicated to shorter-range wireless communications such as Wi-Fi or Bluetooth, and a second communication chip 1912 may be dedicated to longer-range wireless communications such as global positioning system (GPS), EDGE, GPRS, CDMA, WiMAX, LTE, EV-DO, or others. In some embodiments, a first communication chip 1912 may be dedicated to wireless communications, and a second communication chip 1912 may be dedicated to wired communications.

The computing device 1900 may include battery/power circuitry 1914. The battery/power circuitry 1914 may include one or more energy storage devices (e.g., batteries or capacitors) and/or circuitry for coupling components of the computing device 1900 to an energy source separate from the computing device 1900 (e.g., AC line power).

The computing device 1900 may include a display device 1906 (or corresponding interface circuitry, as discussed above). The display device 1906 may include any visual indicators, such as a heads-up display, a computer monitor, a projector, a touchscreen display, a liquid crystal display (LCD), a light-emitting diode display, or a flat panel display, for example.

The computing device 1900 may include an audio output device 1908 (or corresponding interface circuitry, as discussed above). The audio output device 1908 may include any device that generates an audible indicator, such as speakers, headsets, or earbuds, for example.

The computing device 1900 may include an audio input device 1918 (or corresponding interface circuitry, as discussed above). The audio input device 1918 may include any device that generates a signal representative of a sound, such as microphones, microphone arrays, or digital instruments (e.g., instruments having a musical instrument digital interface (MIDI) output).

The computing device 1900 may include a GPS device 1916 (or corresponding interface circuitry, as discussed above). The GPS device 1916 may be in communication with a satellite-based system and may receive a location of the computing device 1900, as known in the art.

The computing device 1900 may include another output device 1910 (or corresponding interface circuitry, as discussed above). Examples of the other output device 1910 may include an audio codec, a video codec, a printer, a wired or wireless transmitter for providing information to other devices, or an additional storage device.

The computing device 1900 may include another input device 1920 (or corresponding interface circuitry, as discussed above). Examples of the other input device 1920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1900 may have any desired form factor, such as a handheld or mobile computer system (e.g., a cell phone, a smart phone, a mobile internet device, a music player, a tablet computer, a laptop computer, a netbook computer, an ultrabook computer, a PDA, an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1900 may be any other electronic device that processes data.

### SELECT EXAMPLES

The following paragraphs provide various examples of the embodiments disclosed herein.

Example 1 provides a method for deep learning, including receiving an activation transfer task for writing activations of a convolution from a local memory of a compute block performing the convolution into an external memory; reading the activations from the local memory; compressing the activations to generate compressed activation data; writing the compressed activation data into the external memory; and storing a size of the compressed activation data in the local memory.

Example 2 provides the method of example 1, further including receiving another activation transfer task for writing the activations from the external memory into the local memory; reading the size of the compressed activation data from the local memory; reading the compressed activation data from the external memory based on the size of the compressed activation data; decompressing the compressed activation data to restore the activations; and writing the activations into the local memory.

Example 3 provides the method of example 2, where reading the compressed activation data from the external memory includes reading the compressed activation data from the external memory after reading the size of the compressed activation data from the local memory.

Example 4 provides the method of any of the preceding examples, where the size of the compressed activation data indicates a number of bytes in the compressed activation data.

Example 5 provides the method of any of the preceding examples, where the activations are stored in a first storage unit in the local memory, and the size of the compressed activation data is stored in a second storage unit in the local memory.

Example 6 provides the method of any of the preceding examples, where the compressed activation data includes non-zero valued activations in a plurality of activation vectors, each activation vector includes a sequence of activations corresponding to different channels of the convolution, and sparsity bitmaps of the plurality of activation vectors, where each sparsity bitmap corresponds to a respective activation vector of the plurality of activation vectors and includes a sequence of bits, each of which corresponds to an activation in the respective activation vector and indicates whether the activation has a zero value or non-zero value.

Example 7 provides the method of example 6, where compressing the activations to generate compressed activation data includes forming a plurality of data packages from the non-zero valued activations and the sparsity bitmaps, where each data package includes a sparsity bitmap and non-zero valued activations in an activation vector corresponding to the sparsity bitmap.

Example 8 provides the method of example 7, where each data package further includes a header that indicates a number of the non-zero valued activations in the activation vector.

Example 9 provides the method of example 8, where the header is arranged between the sparsity bitmap and the non-zero valued activations in the activation vector.

Example 10 provides the method of any one of examples 6-9, where the plurality of activation vector includes a first activation vector and a second activation vector, non-zero valued activations of the first activation vector are arranged before non-zero valued activations of the second activation vector, and the compressed activation data further includes a zero valued datapoint between the non-zero valued activations of the first activation vector and the non-zero valued activations of the second activation vector.

Example 11 provides a DNN accelerator, including a compute block configured to perform a convolution, the compute block including a local memory; a DMA engine configured to: receive an activation transfer task for writing activations of the convolution from the local memory into an external memory associated with the DNN accelerator, and read the activations from the local memory; and an acceleration module configured to: compress the activations to generate compressed activation data, write the compressed activation data into the external memory, and store a size of the compressed activation data in the local memory

Example 12 provides the DNN accelerator of example 11, where the DMA engine is further configured to receive another activation transfer task for writing the activations from the external memory into the local memory, read the size of the compressed activation data from the local memory, and read the compressed activation data from the external memory based on the size of the compressed activation data, and the acceleration module is further configured to decompress the compressed activation data to restore the activations, and write the activations into the local memory.

Example 13 provides the DNN accelerator of example 12, where the DMA engine is configured to read the compressed activation data from the external memory after reading the size of the compressed activation data from the local memory.

Example 14 provides the DNN accelerator of any one of examples 11-13, where the size of the compressed activation data indicates a number of bytes in the compressed activation data.

Example 15 provides the DNN accelerator of any one of examples 11-14, where the activations are stored in a first storage unit in the local memory, and the size of the compressed activation data is stored in a second storage unit in the local memory.

Example 16 provides the DNN accelerator of any one of examples 11-15, where the compressed activation data includes non-zero valued activations in a plurality of activation vectors, each activation vector includes a sequence of activations corresponding to different channels of the convolution, and sparsity bitmaps of the plurality of activation vectors, where each sparsity bitmap corresponds to a respective activation vector of the plurality of activation vectors and includes a sequence of bits, each of which corresponds to an activation in the respective activation vector and indicates whether the activation has a zero value or non-zero value.

Example 17 provides the DNN accelerator of example 16, where the accelerator module is configured to compress the activations to generate compressed activation data by forming a plurality of data packages from the non-zero valued activations and the sparsity bitmaps, where each data package includes a sparsity bitmap and non-zero valued activations in an activation vector corresponding to the sparsity bitmap.

Example 18 provides the DNN accelerator of example 17, where each data package further includes a header that indicates a number of the non-zero valued activations in the activation vector.

Example 19 provides the DNN accelerator of example 18, where the header is arranged between the sparsity bitmap and the non-zero valued activations in the activation vector.

Example 20 provides the DNN accelerator of any one of examples 16-19, where the plurality of activation vector includes a first activation vector and a second activation vector, non-zero valued activations of the first activation vector are arranged before non-zero valued activations of the second activation vector, and the compressed activation data further includes a zero valued datapoint between the non-zero valued activations of the first activation vector and the non-zero valued activations of the second activation vector.

Example 21 provides a system for deep learning, the system including a first memory; a compiler configured to generate an activation transfer task for transferring activations of a convolution from a second memory to the first memory; a compute block configured to perform the convolution, the compute block including the second memory; a DMA engine configured to receive the activation transfer task, and read the activations from the second memory; and an acceleration module configured to compress the activations to generate compressed activation data, write the compressed activation data into the first memory, and store a size of the compressed activation data in the second memory.

Example 22 provides the system of example 21, where the compiler is further configured to generate an additional activation transfer task for transferring the activations from the first memory to the second memory, the DMA engine is further configured to receive the additional activation transfer task, read the size of the compressed activation data from the second memory, and read the compressed activation data from the first memory based on the size of the compressed activation data, and the acceleration module is further configured to decompress the compressed activation data to restore the activations, and write the activations into the second memory.

Example 23 provides the system of example 21 or 22, where the compressed activation data includes non-zero valued activations in a plurality of activation vectors, each activation vector includes a sequence of activations corresponding to different channels of the convolution, and sparsity bitmaps of the plurality of activation vectors, where each sparsity bitmap corresponds to a respective activation vector of the plurality of activation vectors and includes a sequence of bits, each of which corresponds to an activation in the respective activation vector and indicates whether the activation has a zero value or non-zero value.

Example 24 provides the system of example 23, where the accelerator module is configured to compress the activations to generate compressed activation data by forming a plurality of data packages from the non-zero valued activations and the sparsity bitmaps, where each data package includes a sparsity bitmap and non-zero valued activations in an activation vector corresponding to the sparsity bitmap.

Example 25 provides the system of any one of examples 21-24, where the plurality of activation vector includes a first activation vector and a second activation vector, non-zero valued activations of the first activation vector are arranged before non-zero valued activations of the second activation vector, and the compressed activation data further includes a zero valued datapoint between the non-zero valued activations of the first activation vector and the non-zero valued activations of the second activation vector.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method for deep learning, comprising:
receiving an activation transfer task for writing activations of a convolution from a local memory of a compute block performing the convolution into an external memory;
reading the activations from the local memory;
compressing the activations to generate compressed activation data;
writing the compressed activation data into the external memory; and
storing a size of the compressed activation data in the local memory.

2. The method of claim 1, further comprising:
receiving another activation transfer task for writing the activations from the external memory into the local memory;
reading the size of the compressed activation data from the local memory;
reading the compressed activation data from the external memory based on the size of the compressed activation data;
decompressing the compressed activation data to restore the activations; and
writing the activations into the local memory.

3. The method of claim 2, wherein reading the compressed activation data from the external memory comprises:
reading the compressed activation data from the external memory after reading the size of the compressed activation data from the local memory.

4. The method of claim 1, wherein the size of the compressed activation data indicates a number of bytes in the compressed activation data.

5. The method of claim 1, wherein the activations are stored in a first storge unit in the local memory, and the size of the compressed activation data is stored in a second storage unit in the local memory.

6. The method of claim 1, wherein the compressed activation data comprises:
non-zero valued activations in a plurality of activation vectors, each activation vector comprises a sequence of activations corresponding to different channels of the convolution, and
sparsity bitmaps of the plurality of activation vectors,
wherein each sparsity bitmap corresponds to a respective activation vector of the plurality of activation vectors and comprises a sequence of bits, each of which corresponds to an activation in the respective activation vector and indicates whether the activation has a zero value or non-zero value.

7. The method of claim 6, wherein compressing the activations to generate compressed activation data comprises:
forming a plurality of data packages from the non-zero valued activations and the sparsity bitmaps,
wherein each data package comprises a sparsity bitmap and non-zero valued activations in an activation vector corresponding to the sparsity bitmap.

8. The method of claim 7, wherein each data package further comprises a header that indicates a number of the non-zero valued activations in the activation vector.

9. The method of claim 8, wherein the header is arranged between the sparsity bitmap and the non-zero valued activations in the activation vector.

10. The method of claim 6, wherein:
the plurality of activation vectors comprises a first activation vector and a second activation vector,
non-zero valued activations of the first activation vector are arranged before non-zero valued activations of the second activation vector, and
the compressed activation data further comprises a zero valued datapoint between the non-zero valued activations of the first activation vector and the non-zero valued activations of the second activation vector.

11. A deep neural network (DNN) accelerator, comprising:
a compute block configured to perform a convolution, the compute block comprising a local memory;
a direct memory access (DMA) engine configured to:
receive an activation transfer task for writing activations of the convolution from the local memory into an external memory associated with the DNN accelerator, and
read the activations from the local memory; and
an acceleration module configured to:
compress the activations to generate compressed activation data,
write the compressed activation data into the external memory, and
store a size of the compressed activation data in the local memory.

12. The DNN accelerator of claim 11, wherein:
the DMA engine is further configured to:
receive another activation transfer task for writing the activations from the external memory into the local memory,
read the size of the compressed activation data from the local memory, and
read the compressed activation data from the external memory based on the size of the compressed activation data, and
the acceleration module is further configured to:
decompress the compressed activation data to restore the activations, and
write the activations into the local memory.

13. The DNN accelerator of claim 12, wherein the DMA engine is configured to read the compressed activation data from the external memory after reading the size of the compressed activation data from the local memory.

14. The DNN accelerator of claim 11, wherein the size of the compressed activation data indicates a number of bytes in the compressed activation data.

15. The DNN accelerator of claim 11, wherein the activations are stored in a first storage unit in the local memory, and the size of the compressed activation data is stored in a second storage unit in the local memory.

16. The DNN accelerator of claim 11, wherein the compressed activation data comprises:
non-zero valued activations in a plurality of activation vectors, each activation vector comprises a sequence of activations corresponding to different channels of the convolution, and
sparsity bitmaps of the plurality of activation vectors,
wherein each sparsity bitmap corresponds to a respective activation vector of the plurality of activation vectors and comprises a sequence of bits, each of which corresponds to an activation in the respective activation vector and indicates whether the activation has a zero value or non-zero value.

17. The DNN accelerator of claim 16, wherein the accelerator module is configured to compress the activations to generate compressed activation data by forming a plurality of data packages from the non-zero valued activations and the sparsity bitmaps, wherein each data package comprises a sparsity bitmap and non-zero valued activations in an activation vector corresponding to the sparsity bitmap.

18. The DNN accelerator of claim 17, wherein each data package further comprises a header that indicates a number of the non-zero valued activations in the activation vector.

19. The DNN accelerator of claim 18, wherein the header is arranged between the sparsity bitmap and the non-zero valued activations in the activation vector.

20. The DNN accelerator of claim 16, wherein:
the plurality of activation vectors comprises a first activation vector and a second activation vector,
non-zero valued activations of the first activation vector are arranged before non-zero valued activations of the second activation vector, and
the compressed activation data further comprises a zero valued datapoint between the non-zero valued activations of the first activation vector and the non-zero valued activations of the second activation vector.

21. A system for deep learning, the system comprising:
a first memory;
a compiler configured to generate an activation transfer task for transferring activations of a convolution from a second memory to the first memory;
a compute block configured to perform the convolution, the compute block comprising the second memory;
a direct memory access (DMA) engine configured to:
receive the activation transfer task, and
read the activations from the second memory; and
an acceleration module configured to:
compress the activations to generate compressed activation data,
write the compressed activation data into the first memory, and
store a size of the compressed activation data in the second memory.

22. The system of claim 21, wherein:
the compiler is further configured to generate an additional activation transfer task for transferring the activations from the first memory to the second memory,
the DMA engine is further configured to
receive the additional activation transfer task,
read the size of the compressed activation data from the second memory, and
read the compressed activation data from the first memory based on the size of the compressed activation data, and
the acceleration module is further configured to:
decompress the compressed activation data to restore the activations, and
write the activations into the second memory.

23. The system of claim 21, wherein the compressed activation data comprises:
non-zero valued activations in a plurality of activation vectors, each activation vector comprises a sequence of activations corresponding to different channels of the convolution, and
sparsity bitmaps of the plurality of activation vectors,
wherein each sparsity bitmap corresponds to a respective activation vector of the plurality of activation vectors and comprises a sequence of bits, each of which corresponds to an activation in the respective activation vector and indicates whether the activation has a zero value or non-zero value.

24. The system of claim 23, wherein the accelerator module is configured to compress the activations to generate compressed activation data by forming a plurality of data packages from the non-zero valued activations and the sparsity bitmaps, wherein each data package comprises a sparsity bitmap and non-zero valued activations in an activation vector corresponding to the sparsity bitmap.

25. The system of claim 21, wherein:
the plurality of activation vector comprises a first activation vector and a second activation vector,
non-zero valued activations of the first activation vector are arranged before non-zero valued activations of the second activation vector, and
the compressed activation data further comprises a zero valued datapoint between the non-zero valued activations of the first activation vector and the non-zero valued activations of the second activation vector.
